(19) United States
(12) Patent Application Publication
(10) Pub. No.: US 2014/0113713 A1
(43) Pub. Date: Apr. 24, 2014

(54) RANDOM BASED CONCURRENT, MULTI-VENUE, MULTI-RACE, MULTI-OUTCOME PROGRESSIVE PARI-MUTUEL WAGERS

(71) Applicants: Anthony deLisle Fontaine, Henderson, NV (US); Michael Jay Staw, Westport, CT (US)

(72) Inventors: Anthony deLisle Fontaine, Henderson, NV (US); Michael Jay Staw, Westport, CT (US)

(21) Appl. No.: 14/144,293

(22) Filed: Dec. 30, 2013

Related U.S. Application Data
(63) Continuation-in-part of application No. 12/763,556, filed on Apr. 20, 2010, now Pat. No. 8,616,947.

(51) Int. Cl. G07F 17/32

(52) U.S. Cl. CPC G07F 17/3258
USPC 463/28

(57) ABSTRACT

A system generates multiple presentations, or game play opportunities, based upon a single defined value set relating to a wager produced by the outcome of concurrent, multi-venue, multi-event, multi-outcome horse racing pari-mutuel wager. Once the wager has been defined, the events comprising the dataset of wagers are arranged sequentially. One or more random number generators are utilized to distribute the dataset elements as well as corresponding numbers, symbols or images in a random rather than sequential fashion thereby resulting in multiple unique game play opportunities.

### CROSS REFERENCE TO RELATED APPLICATIONS

The present application is a continuation-in-part and claims the priority benefit of U.S. patent application Ser. No. 12/763,556 filed Apr. 20, 2010, which will issue as U.S. Pat. No. 8,616,947 on Dec. 31, 2013, titled “Method and System for Conducting Concurrent Multi-Venue Multi-Race Multi-Outcome Progressive Pari-Mutuel Wagering,” the disclosure of which is incorporated herein by reference.

### BACKGROUND

1. Field of the Invention The present invention relates to wagering and, more specifically, to a method for developing and conducting games based on concurrent multi-venue, multi-race, multi-outcome progressive pari-mutuel wagering.

2. Prior Art

Games of the prior art disclose using pari-mutuel pools for electronic gaming whereby players compete against each other in electronic forms of video poker, craps and blackjack with random number generators utilized in conjunction with the placement of a pari-mutuel wager. Previously, the results of past pari-mutuel events (horse/dog racing, jai alai) are combined with a weighted random number generator to select the order of finish to enable players to wager in a slot machine format.

A previous system envisions sporting events where all possible outcomes of the event are assigned values which are then matched to a 3×3 grid corresponding to those outcomes. In this invention, the sequence and exact order of finish determine the outcome of the game. This is a fundamentally different concept from using the outcome of the event as the random number as in the present invention. The events and/or order of finish are irrelevant to game play in the existing patent and this continuation. The event is relevant only in that it is completed with one or more expected outcomes.

Horse Racing Bingo, http://www.playhorseracingbingo.com, provides an entertainment game developed to increase fan awareness and educate consumers about the sport of horse racing. In Horse Racing Bingo, 24 different events, corresponding to various events at a single racetrack occupy different spots on the Bingo card. As the races take place at the track, the player checks off the corresponding event on the card, if and when the event occurs. If all 24 events take place, the player wins (the center spot is free). If a player fills the entire 24 spots, or gets a bingo on one of the weekly patterns, the player wins cash or prizes.

While Horse Racing Bingo is a variation on the traditional game of bingo, it is not truly bingo. In traditional bingo games, the cards are physically printed on paper or other suitable material. These printed cards are purchased by players prior to the start of a game. Once all the cards for a game have been purchased, game designations from the available pool of game designations are selected at random. As the game designations are selected and announced in the game, the players match the randomly selected game designations with the designations printed on their respective card or cards. When defining any new variation of the game of Bingo, it is essential that the game retain the basic characteristics of a bingo game, namely that the game is played with predefined cards or card representations which the players match or daub against randomly generated game designations, and the game winner is the first player to match the designations in a predetermined winning pattern on his or her card or card representation. In Horse Racing Bingo the player is not in competition with other players for a prize. Due to the nature of the events on the card, an event may not happen, while in Bingo, there is always an equal chance that the event will occur; each ball in the game has the same 1 in 75 odds of being drawn. In Horse Racing Bingo the player is merely tracking events that may or may not occur, like a $0.10 superfecta that pays over $100 or an exacta that pays over $100.

There have been various attempts by pari-mutuel venues to attract individuals who are attracted either to simpler wagering activities or the potential for a larger payout. For example; random wagers, sometimes referred to as “quick picks”, have been offered at pari-mutuel venues to satisfy those patrons who prefer simpler wagering activities.

Luckity.com (www.luckity.com/) is an example of simplifying the wagering experience and utilizing an animated display to reflect the result of a specific horse race, or of a specific wager placed at a specific track thereby simplifying the wagering experience. Cash bingo game prizes and winners are determined by the outcomes of live horse races taking place worldwide. Each cash bingo card purchased is randomly associated with a specific horse in a specific race, much like a Lottery Quick Pick. In essence, every bingo card relates to a specific wager on an undisclosed racing event. Playing multiple cards in Luckity is placing wagers on two discreet racing events.

For those individuals who have placed a winning wager such that their prediction matches an actual event outcome, their payout is determined, in part, by the size of the pool as defined by the total amount of wagers placed for a given event and, in part, by the specific wagers made by other bettors. Thus, for example, if a defined prize pool is to be paid out to those wagers which selected runner X as the winner and, for example, 20 (twenty) individual wagers were placed on runner X to win, the prize pool will be divided among those 20 (twenty) bettors in proportion to the amount each of the (twenty) individual bettors wagered on such an outcome.

### SUMMARY

The premise for a multi-event, multi-wager, multi-outcome based pari-mutuel wager is to provide a unique, fast paced game that can be completed in far less time than a traditional Pick “N” wager. However, given that there are only a finite number of races run each day, the supply of outcomes remains limited and game play remains dependent on the limited supply.

In order to maximize the total number of wagering opportunities presented by a limited number of outcomes, to create a wager, or dataset, the dataset should be manipulated to provide additional wagering opportunities without corrupting the integrity of the original wager. To accomplish this, one or more random number generators may be employed against the original dataset and objects or images relating to each dataset element. In this way a multiplicity of game opportunities can be defined relating to a multiplicity of numbers, symbols or images.

An important factor in attracting patron interest is the size and frequency of the probable jackpot that a patron can expect to win. Thus, it is desirable to provide relatively large jackpots available in a faster timeframe than is currently offered in the sport. A pari-mutuel wager can now take the form of commonly played and easily understood games like keno, poker, bingo, pai gow, baccarat, etc.

By defining multiple game play opportunities in this manner, as long as the initial wager takes place prior to the first event, presentation of the wager, and contributions to the pool can occur simultaneously in multiple play presentations, whose resolution can occur over an extended period of time. With this approach, new game definitions can range from simple keno and symbol match games to more complicated games like bingo and poker.

In a simple match game, the event outcomes can be mapped to any of an infinite number of representations with game rules relating to the symbols that must be matched or obtained. The events may be randomized for display rather than shown in sequential order, thereby providing a greater level of interest to the game and offering a perceived complexity. Matching symbols may be as simple as scratch and reveal or a common keno themed game or as complex as a scavenger hunt with complex rules requiring the player to find symbols relating to winning events in order to continue playing.

In the case of a bingo style game, mapped outcomes replace the ball drop or random number generator traditionally used for the caller's card, while random number generated game play cards are used to match the game play to the player's card. Statistically a horse will finish “in the money” (either first, second or third) approximately 67% of the time. (See: Steve Klein, author “The Power of Early Speed”; Handicappers Data Warehouse http://horsedata.com/; Mike DeAngelo, APlus Thorobreds.) This provides an easily assessable event outcome inventory from which the Bingo game outcomes may be determined. However, given this limitation, it can be expected that about 33% of the anticipated outcomes will not be fulfilled. Since the game is event independent, these outcomes can easily be replaced by simply replacing the event with a future event.

Scratches, which are a common occurrence in horse racing, must be accommodated for. Since the wager is predicated on the outcome of an event, the event must take place as required for the bet. In live horse racing scratches are usually accommodated in one of two ways; the wager amount is refunded, or the runner is replaced with the current odds favorite. Runner replacement is the most common accommodation in Pick “N” pool wagers. Since the invention relies upon Win, Place and Show outcomes to construct a Pick “N” pool, the scratched runner may be replaced by either the current odds on favorite or a Money Line favorite in a future race. Replacement with a Money Line favorite in a future race has no bearing in any future wagers constructed with that event, rather the two wagers will share a common event.

In an embodiment, a wager may be conducted by generating a plurality of events by an application. The plurality events may include future events from multiple races at multiple venues. Each of the plurality of events may be randomly associated with an alphanumeric or symbolic character. A playing grid may be generated for a user. The playing grid may include a randomized selection of the alphanumeric or symbolic characters. The randomly selected alphanumeric or symbolic characters may be provided within the grid. A wager may be defined by specifying a predictive pattern-based outcome for a game associated with one or more of the playing grids.

### BRIEF DESCRIPTION OF DRAWINGS

FIG. 1 is a block diagram of a system for conducting a Multi-Venue Wager.

FIG. 2 is a block diagram of the system for the setup, display and processing of a multi-event wager.

FIGS. 3A and 3B are diagrams depicting an exemplary Multi-Venue administration application for the definition of a Multi-Venue Wager.

FIG. 3C is a diagram depicting the entry of racetrack fees.

FIG. 3D is an example of Host Fee calculations.

FIG. 3E is a diagram depicting the same process using a $2 ticket as an example.

FIGS. 4A through 4D are diagrams further depicting the Multi-Venue administration application for the setup of a Multi-Venue Wager.

FIG. 5 is a flowchart depicting the process by which a Multi-Venue Wager is defined and processed.

FIGS. 6A through 6F are diagrams showing an example of a Pick 5, Play Any Event, Multi-Venue Wager display.

FIG. 7 is a diagram showing an exemplary wager confirmation.

FIGS. 8A and 8B are diagrams showing an example of a concurrent pool display depicting the sequential and progressive nature of the pools.

FIGS. 9A, 9B, and 9C show exemplary calculations of payout odds.

FIG. 10 is a block diagram illustrating a computing device as utilized for receiving wagers and determining winnings.

FIG. 11 is a block diagram of the system using information delivered through an XML web service.

FIG. 12 is a block diagram further describing the game definition process for the game of keno.

FIG. 13 is a depiction of the relationship of the Mapping Application used in conjunction with a random number generator to prior to the random number randomization of the events.

FIG. 14 is a block diagram of the game illustrating the effect of the random number generator on the sequential events, and the final ball selection to be used for the game.

FIG. 15 depicts the Keno Game Play Application connected to an Advance Deposit Wagering System (ADW) and game play.

FIG. 16 is a block diagram illustrating the Multi-Venue Administrative Application Process for the creation of the game Texas Hold 'em.

FIG. 17 is a block diagram illustrating the integration of the Texas Hold 'em Game Play Application with an Advance Deposit Wagering system operator.

FIG. 18 is a block diagram depicting the process to ensure a successful outcome is mapped to the appropriate card value when a previously mapped event fails to produce a successful outcome.

FIG. 19 is a block diagram of the deck of cards used during game play after event substitution.

FIG. 20 is a depiction of the application of two random number generators to produce a game requiring the mapping of two separate criteria.

FIG. 21 is a block diagram depicting the creation of the Bingo Game Application, Callers Card and Players Card, and displaying other game play attributes.

FIG. 22 is a block diagram depicting the Bingo game Play Application and game play through and Advance Deposit Wagering System.

FIG. 23 is a block diagram of a computing environment.

### DETAILED DESCRIPTION

The premise for a multi-event, multi-wager, multi-outcome based pari-mutuel wager is to provide a unique, fast paced game that can be completed in far less time than a traditional Pick “N” wager. However, given that there are only a finite number of races run each day, the supply of outcomes remains limited and game play remains dependent on the limited supply.

In order to maximize the total number of wagering opportunities presented by a limited number of outcomes, to create a wager, or dataset, the dataset should be manipulated to provide additional wagering opportunities without corrupting the integrity of the original wager. To accomplish this, one or more random number generators may be employed against the original dataset and objects or images relating to each dataset element. In this way a multiplicity of game opportunities can be defined relating to a multiplicity of numbers, symbols or images.

An important factor in attracting patron interest is the size and frequency of the probable jackpot that a patron can expect to win. Thus, it is desirable to provide relatively large jackpots available in a faster timeframe than is currently offered in the sport. A pari-mutuel wager can now take the form of commonly played and easily understood games like keno, poker, bingo, pai gow, baccarat, etc.

By defining multiple game play opportunities in this manner, as long as the initial wager takes place prior to the first event, presentation of the wager, and contributions to the pool can occur simultaneously in multiple play presentations, whose resolution can occur over an extended period of time. With this approach, new game definitions can range from simple keno and symbol match games to more complicated games like bingo and poker.

In one aspect, the invention provides a method for conducting a wager. The method includes the steps of identifying a fixed number of sequential race events; defining the wager by specifying a predictive outcome for each race event based upon the favorite horse to win their event; to ensure a minimum pool amount is available for the wager; receiving at least one wager entry; comparing each actual outcome to each predictive outcome for each received wager entry after an actual outcome for each race event has been determined; for each received winning wager entry, determining an amount of winnings to be awarded based the number of winning entries; and a method for determining the fees due to each venue participating in the multi-event wager.

The operator hosting the pool determines the number of events, and the wager types to be offered, whose winning outcomes represent the type of pool to be won. A defined pool requires the player to successfully predict the outcome of the number events defined by the operator. The pool represents the prize money available to players successfully predicting the correct wagers as specified by the operator. The wager may be comprised of all winning outcomes (Win), all second place (Place) outcomes, all third place or Show outcomes, or any combination of Win, Place or Show outcomes. The operator also defines the number of event choices that are made available to the player for selection.

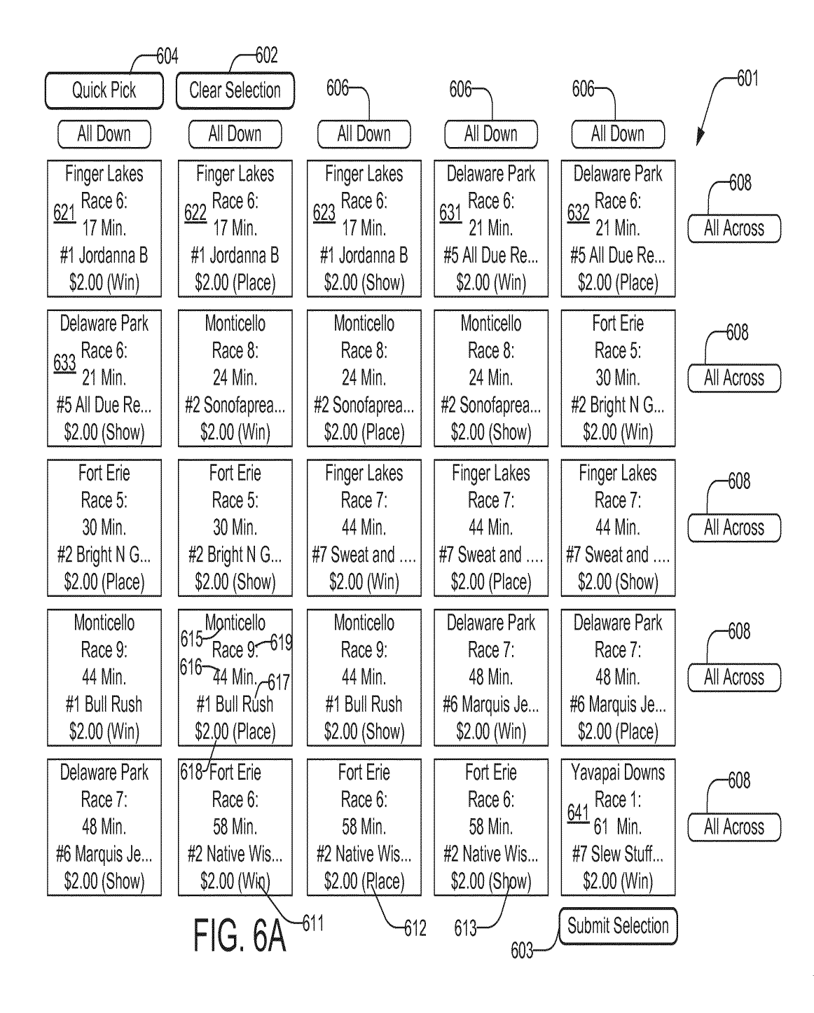

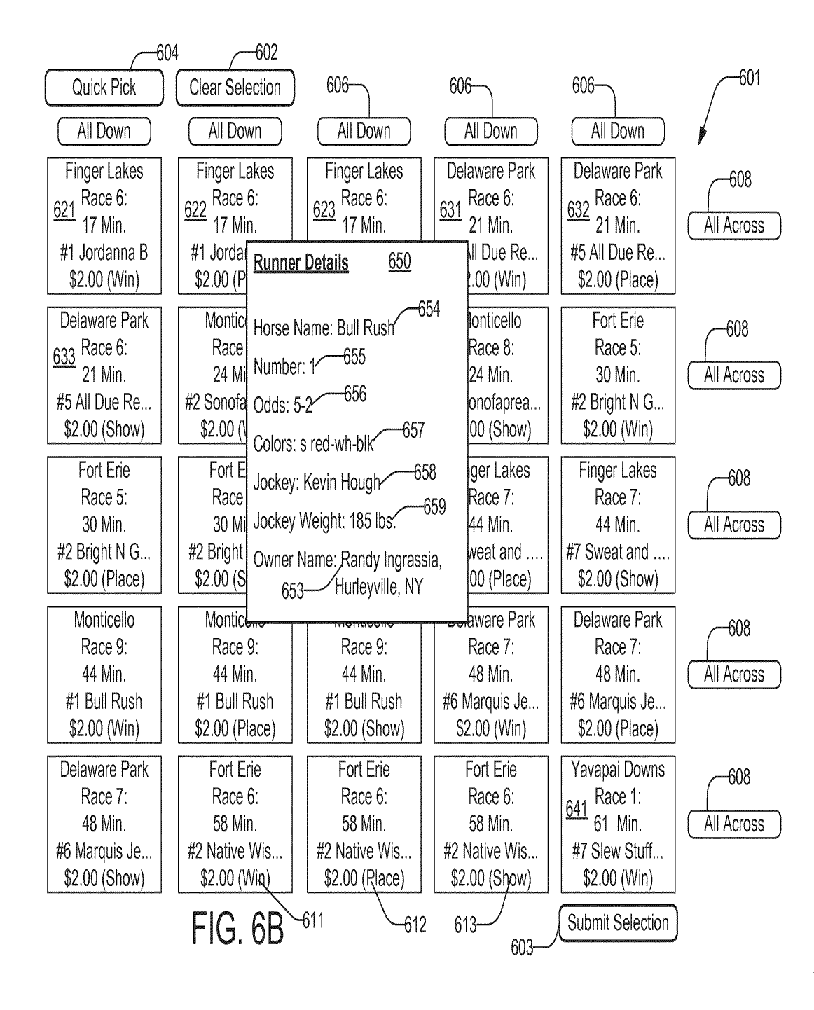

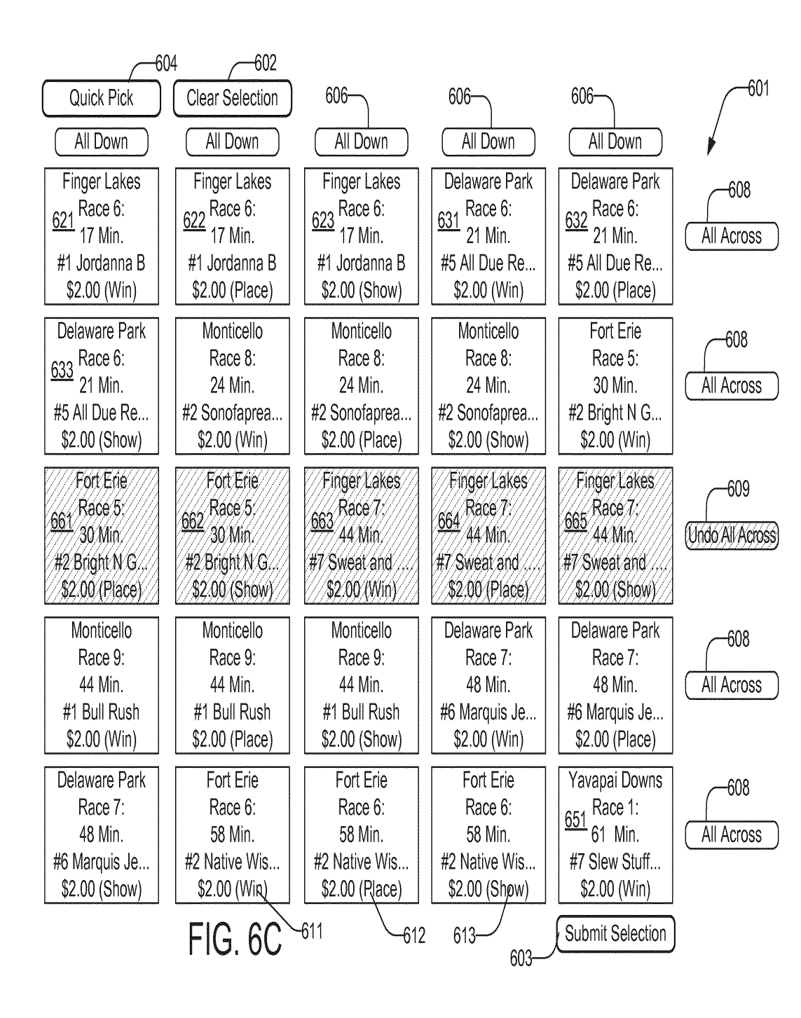

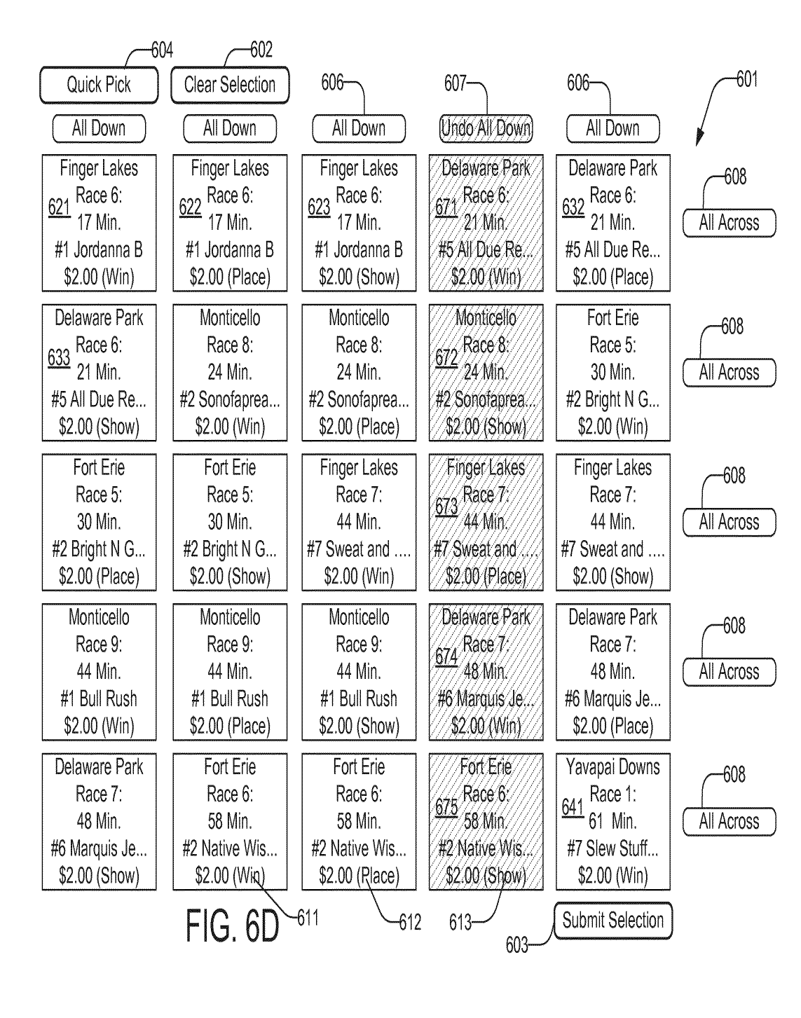

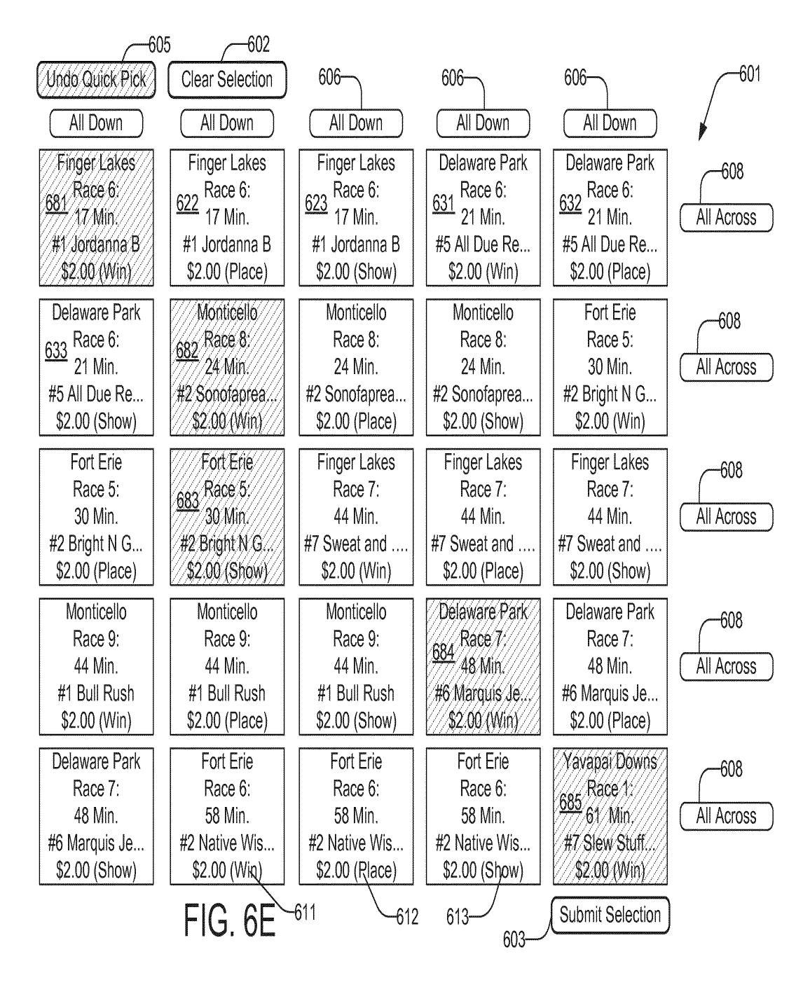

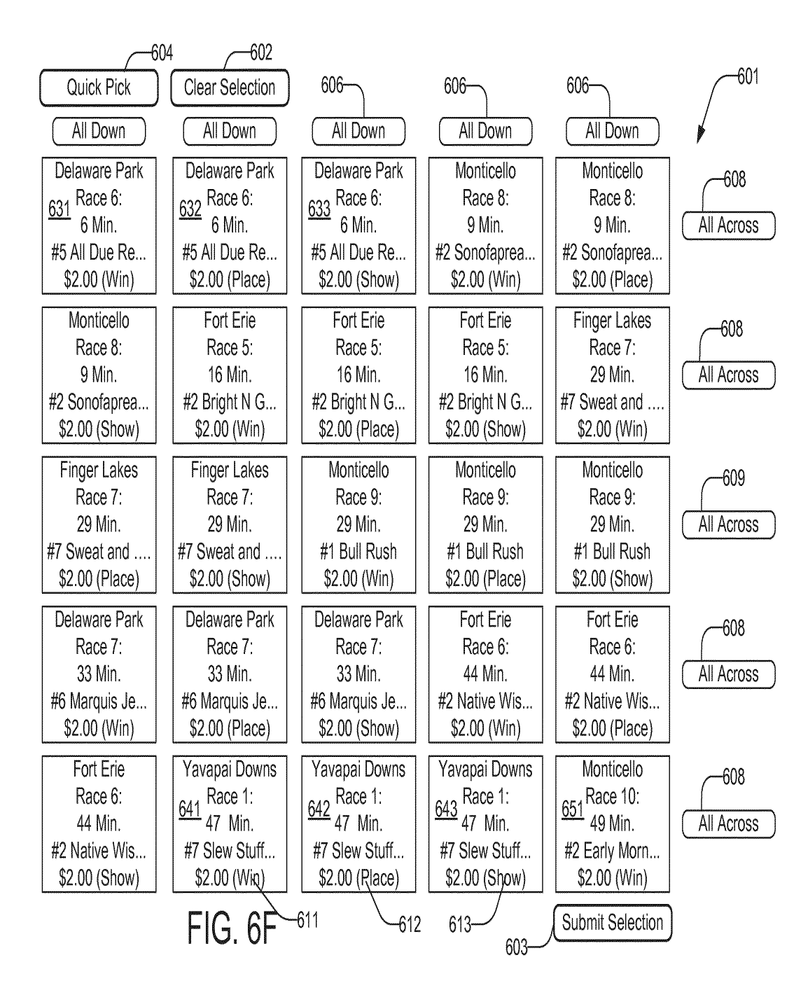

In the attached exemplary embodiment (Multi-Venue Examples) the operator offers a grid of 25 possible event selections (FIG. 6A). These 25 displayed events reflect a predicted outcome whereby the selection in the event is the horse favored to win the event. The favorite is determined by the odds, either the morning line (odds set typically before the commencement of wagering), the odds when a pool opens, or the current odds. Each event is the next race available to the operator for use in the wager. For this example the operator has defined a “Pick Any Five” pool in which the player may select from any of the possible 25 outcomes. A player chooses five selections that comprise the wager. Upon selection the event is highlighted. To assist the player, additional information such as the odds, jockey name and weight, owner, etc. may be provided (FIG. 6B). For this wager the display offers the player several “quick pick” functions including “All Across” (FIG. 6C), “All Down” (FIG. 6D), and “Quick Pick” (FIG. 6E) that randomly makes 5 selections on the player's behalf. A player is not restricted by wager type for the defined pool in this instance. However, if it were a Show pool, the player would be limited to choosing only those wagering events representing a Show wager.

The operator may seed the pool with a starting point for the progressive and may guarantee a minimum prize for a successful wager regardless of the actual contribution by successive pari-mutuel wagers into the pool. Once the pool has been seeded, a portion of each wager is set aside to seed the next pool. The operator may be responsible to seed the pool if there has not been a sufficient amount of contributions to meet the minimum pool prize requirements or the outcome of the preceding pool has not been determined. Therefore, a percentage of each wager is contributed to the prize pool, retained for the purpose of paying fees to participating venues, retained to seed subsequent pools, and retained by the operator as profit.

The step of determining winnings includes determining a correct match between the predictive outcome and the actual outcome for all of the required number of (horse) race events, then determining the number of players having the required number of correct matches, and dividing the prize pool equally amongst the player. In another embodiment, winnings are determined not only by the correct number of predictive matches, but also by the winning amount generated by each individual correct predictive match. In this embodiment several different payout schemes may be implemented including: “winner take all” in which the person with the greatest sum total receives the entire prize pool, or, tiered payouts in which a set percentage of the prize pool amount is awarded corresponding to various predetermined levels, i.e. first, second or third place. Other payout schemes are also within the scope of the present invention.

In another aspect, the invention provides a system for conducting a wager. The system may include a server computer and at least one client computer. The client computer is typically in communication with the server computer via a network. The server computer may be configured to communicate a set of parameters defining the wager to the at least one client computer. The parameters may include an identification of the number of race events and a specified predictive outcome for each race event. The server computer may be further configured to receive from at least one client computer at least one wager entry which includes a prediction corresponding to the specified predictive outcome for each race event. After an actual outcome for each race event has been determined, the server computer may be further configured to compare the actual outcome to the specified predictive outcome for each race event for each received wager entry and, based on a result of the comparing, to determine a level of winnings to be awarded for each received wager entry. Other methodologies are also within the scope of the present invention.

The server computer may be further configured to determine a highest level of winnings corresponding to a correct match between the predictive outcome and the actual outcome for all of the required number of race events, and to determine the various levels of winnings corresponding to a correct match between the predictive outcome and the actual outcome.

The server computer may be further configured to determine the amount of fees that will be paid to participating venues, commonly known as host fees. Unlike all other multievent wagers which transpire at a single venue, the multi-venue nature of the invention requires a more sophisticated method for the determination of host fees. The server computer will typically identify the number of events held at each participating venue for which an entry into the pool was placed and the total number of events held prior to the successful completion of the wager. Each venue will be identified as having a hosted a percentage of events contributing to the total number of events completed during the wagering process. The amount of the pool retained for the purpose of paying host fees is then divided according to the percentage of events held at each venue.

In yet another aspect, the invention provides a wagering game. The game includes a plurality of wager entries and a wagering pool. Each of the plurality of wager entries includes a predictive outcome for each of more than one time sequential, multi-venue predetermined race events. When an actual outcome for each race event has been determined, a percentage amount of the wagering pool is allocated to each of the plurality of wager entries based on a comparison of each predictive outcome to each actual outcome. The game proceeds using the same form and method as for wagering, however it may be played for points rather than actual money.

In a derivative embodiment of the preceding aspect of the present invention, the prize is a fixed payout and is played without the concurrent, sequential, progressive aspect of the invention.

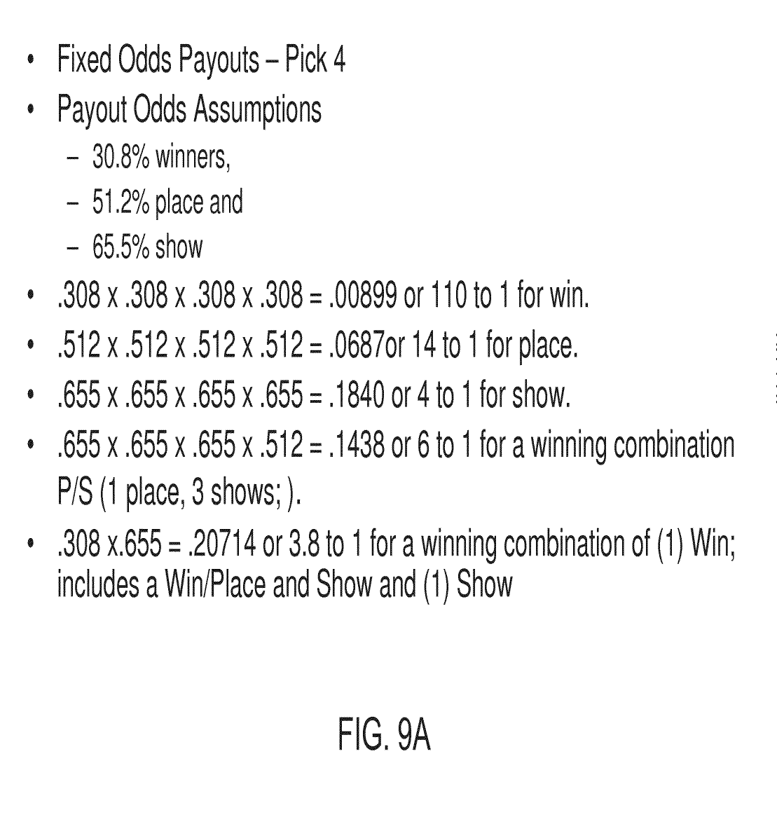

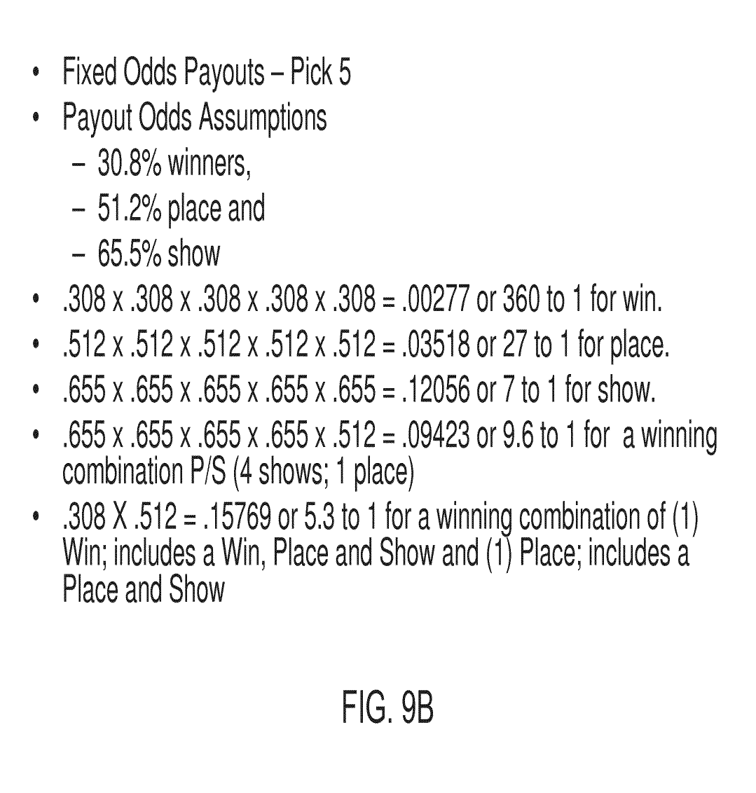

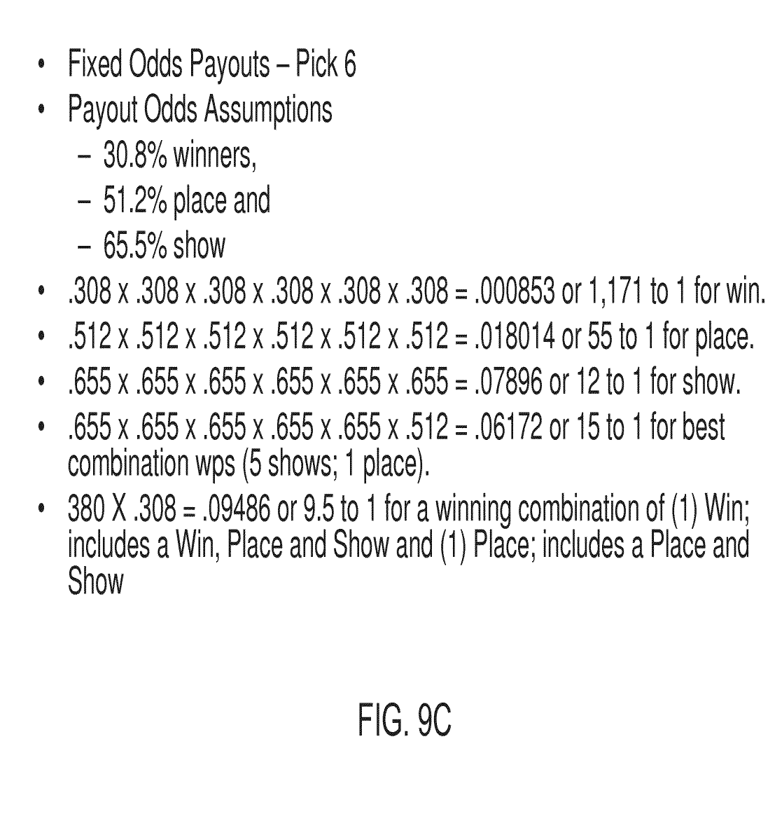

In another embodiment of the present invention, a predetermined number of sequential pari-mutuel events is used to define a fixed odds wager or game. In this embodiment there are no pools and an operator is typically solely responsible for payouts. The operator can make a mathematical determination of the predicted odds for each wager type based upon the events comprising the wager. Exemplary predicted odds for a several Pick 4 wagers are shown in FIG. 9A. Exemplary predicted odds for a Pick 5 wager are shown in FIG. 9B and those for a Pick 6 wager shown in FIG. 9C.

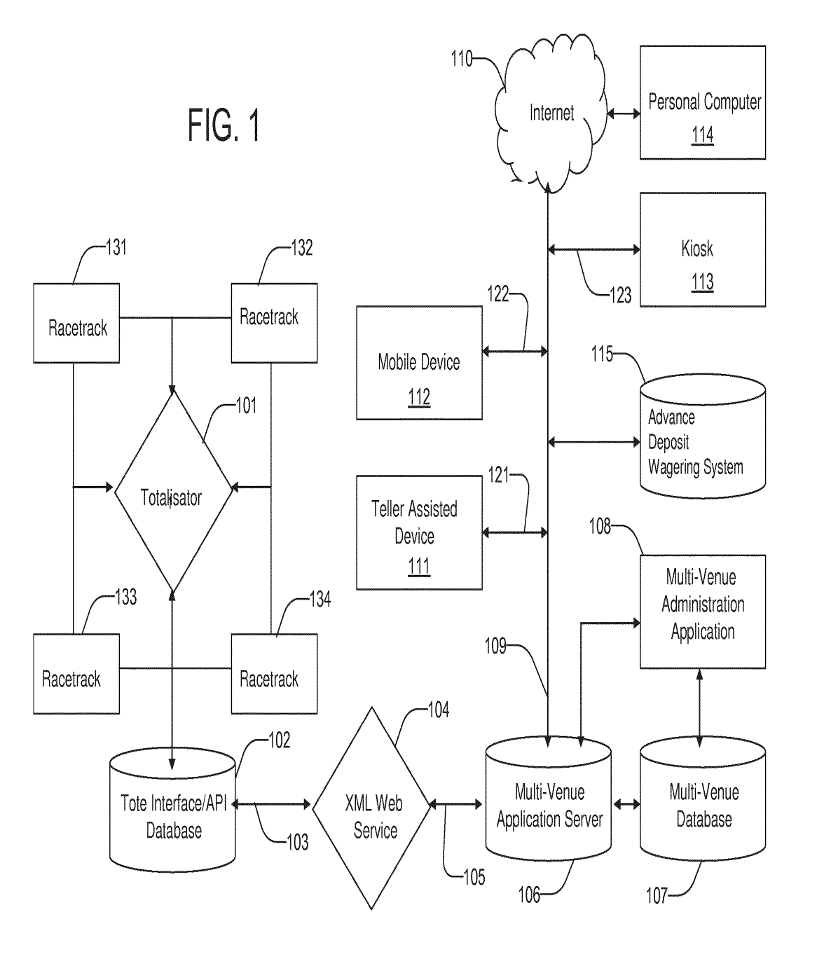

FIG. 1 is a block diagram of a system for conducting a Multi-Venue Wager according to one embodiment of the present invention. According to a preferred embodiment of the invention, a multiplicity of racetracks, or venues (131, 132, 133, 134) that are connected to a Totalisator (101), (also known as a tote) for the purpose of sharing event information including calculating odds, pooling wagers and determining payouts based upon event outcomes, are connected to a tote interface through an API and database (102). A bi-directional interface (103) utilizes an XML Web Service (104) to communicate through a bi-directional interface (105) with a Multi-Venue Application Server (106). The Application Server (106) contains the Multi-Venue Application described further in subsequent drawings. The Server's (106) functions are managed by an Administrative Application (108) and all activity is recorded in a Database (107). The Server communicates via a plurality of bi-directional interfaces (109) including the Internet (110) offering the secure communication of wagering information and wagering data. A variety of wagering devices may be connected to communications interfaces. Teller Assisted Devices (111) may be offered where human interaction with the customer is desirable. In this embodiment of the invention, a teller may accept voice instructions from a customer and manually enter the wager based upon the instructions provided. Common examples of this form of wagering include over-the-counter transactions such as found at race tracks and Off Track Betting parlors, also known as OTBs. Mobile Devices may also be used to access the wagering application through a variety interfaces compatible with SMS messaging, and web application compatible devices such as iPhones, Palms and Blackberrys (112). Kiosk's (113) may be utilized to provide self service access in any physical location over a secure network either and Personal Computers (114) allowing users access from remote locations. For account based wagers, commonly referred to as Advance Deposit Wagers (ADW), the system is connected to an Advance Deposit Wagering System (115) which tracks customer deposits, withdrawals, wagers, settlements, etc.

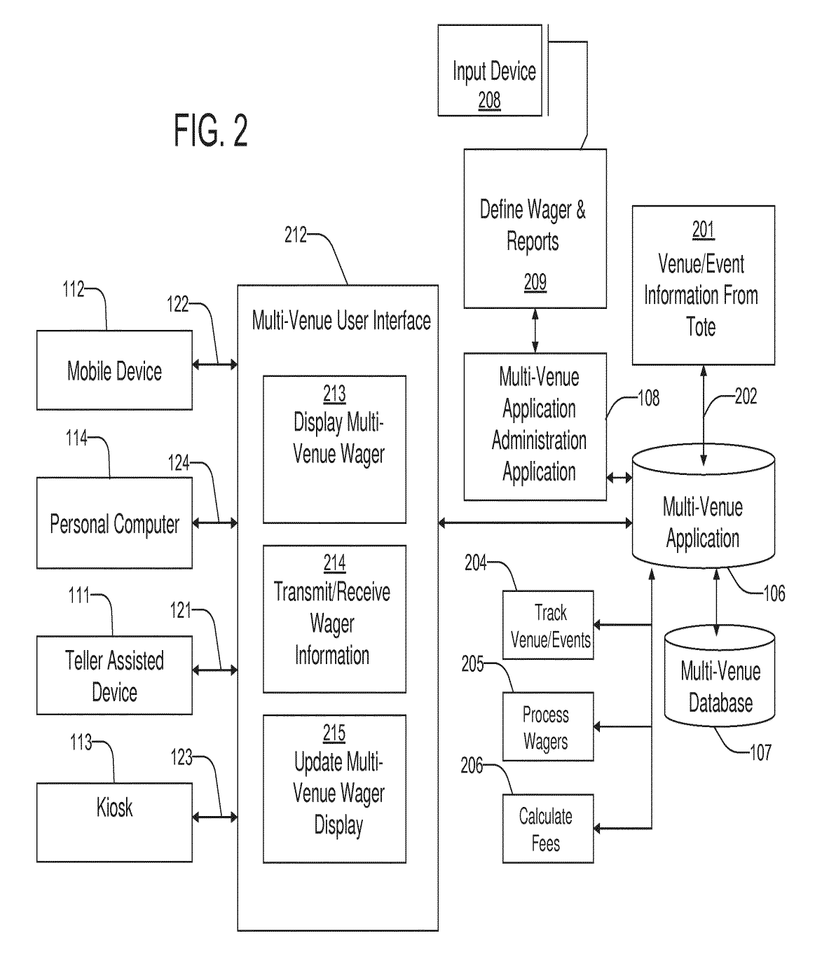

FIG. 2 is a block diagram of the system for the setup, display and processing of a multi-event wager, in accordance with the system shown in FIG. 1. It depicts the functions of the Multi-Venue Wagering application whereby venue event information (201) is received from the various venues through the tote interface (202) by the Multi-Venue Application; MVA (106). The MVA (106) is responsible for tacking and updating all venues and events (204), processing wagers (205), including receiving, tracking, and comparing the predicted outcome of the event to the actual outcome of the event. Once there has been a successful wager, the MV A processes the winning and calculates fees (206). All information relating to the operation of the MV A is stored in a database (107). An MV A (106) is defined by a user via an input device (208) such as a keyboard and monitor connected to the MVA (106). An adjunct application (209) provides a user interface to define the various forms of the wager as well as the specification for any reporting requirements. The wagering application may be displayed on the Multi-Venue User Interface MVUI (212) through which: wagers are displayed (213); wagers are transmitted and confirmations received (214); and constantly updated as required (215). The MVUI (212) may be presented though various secure communications (122, 124, 121, 123) to various target interactive devices, such as: Mobile (112), Personal Computer (114), Teller Assisted (Ill) and Kiosk (113). Other configurations are also within the scope of the present invention.

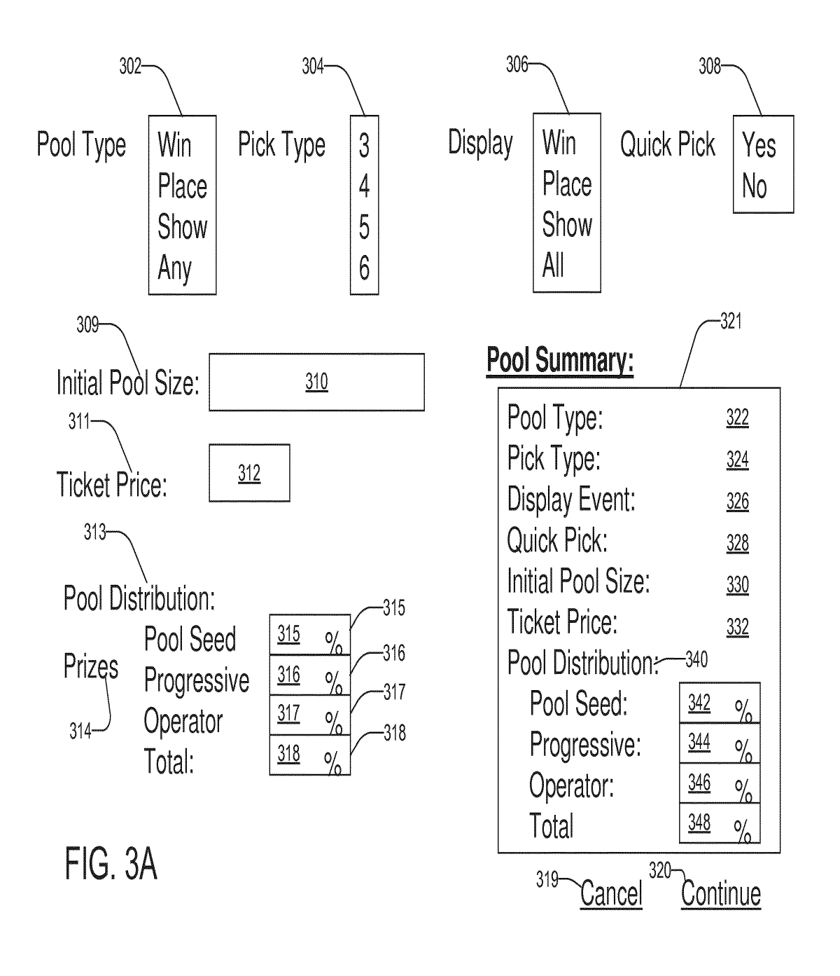

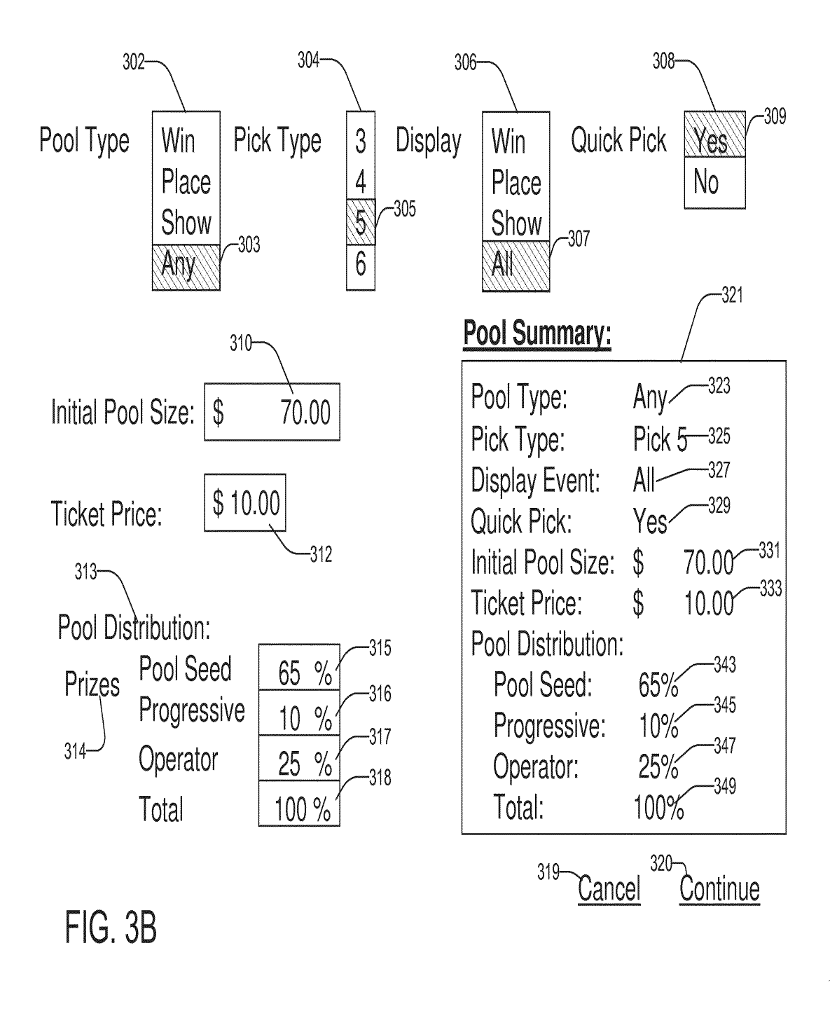

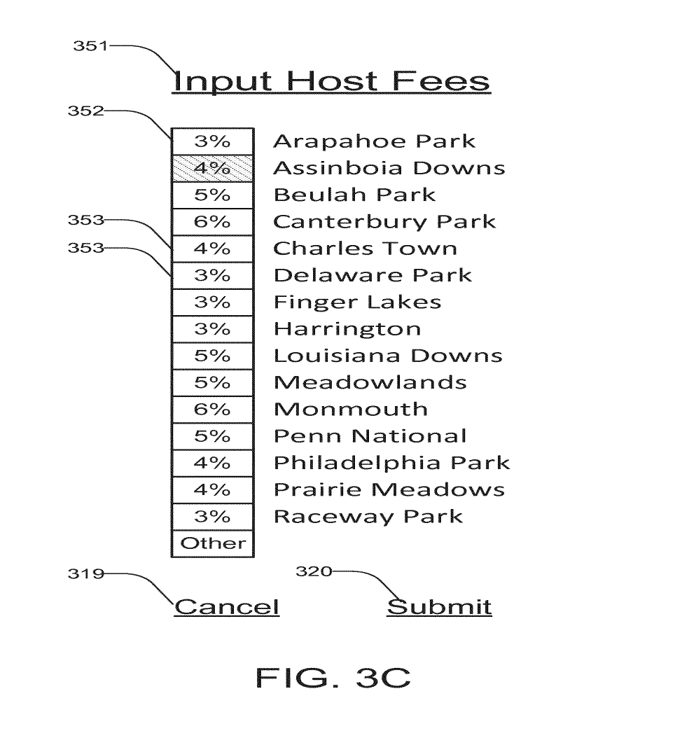

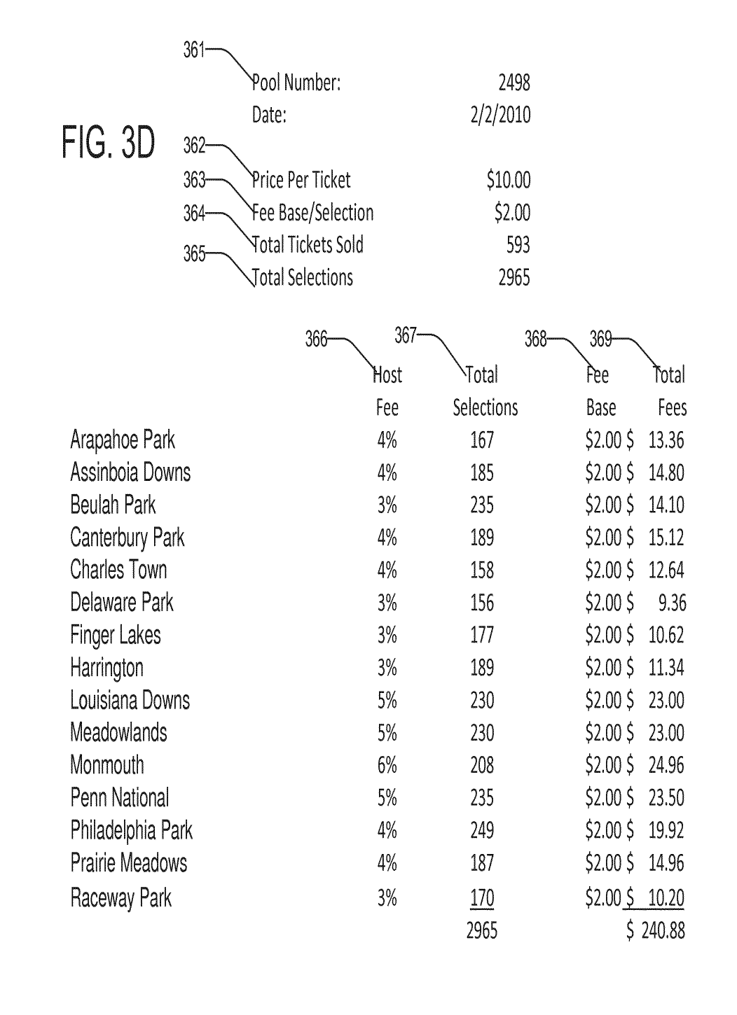

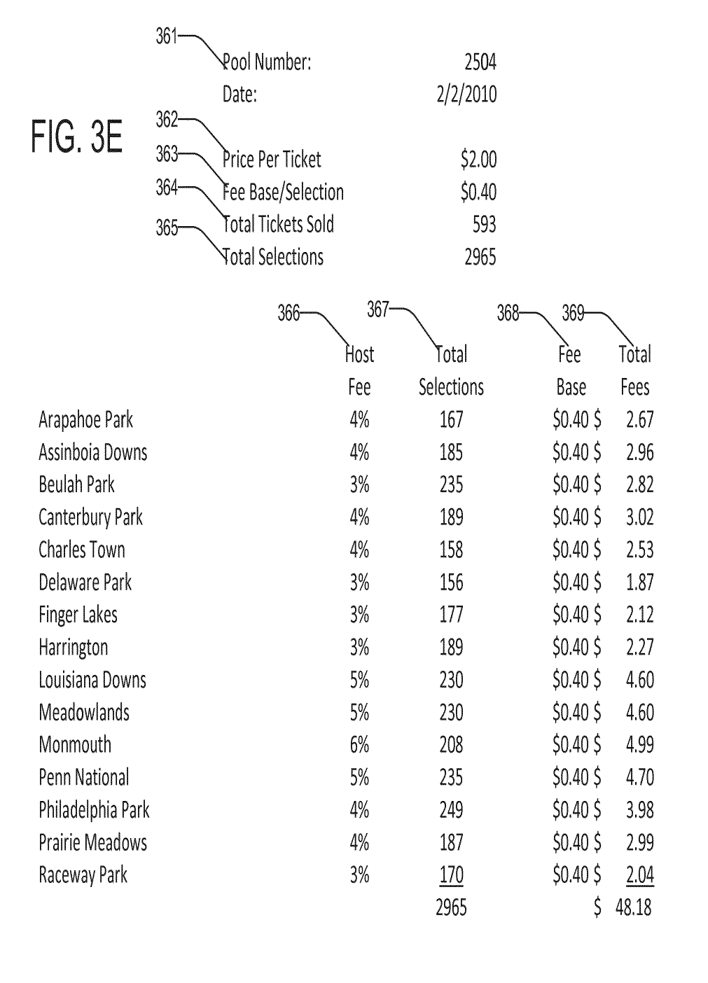

FIG. 3A is a diagram depicting an exemplary Multi-Venue administration application (108) for the definition of a Multi-Venue Wager, in accordance with one embodiment of the present invention. In this and subsequent examples, it is assumed that the amount of winnings is not scored for the purposes determining prize award levels, but rather that multiple winners will share equally in the poor distribution. Other configurations are also within the scope of the present invention. Pool Type selection is preferably accomplished utilizing a drop down menu (302) listing the various pools available for selection. The Pick Type is also preferably selected from a drop down menu (304). A menu corresponding to the Display event field (306) determines which events will be shown. Depending on the Pool Type and the event Display selected, a Quick Pick (308) may be made accessible. The Initial Pool Size (309) determines the amount that the pool will begin with, and is entered in field (310). The price of a ticket (311) is entered in field (312). The Pool Distribution (313) determines how the amount of wagers received into the pool will be distributed. The percentage of each wager to be allocated towards Prizes (314) is distributed between the Pool Seed (315) which is the amount of each wager retained to seed the subsequent pool; and a Progressive (316), the amount of each wager that is added to the current pool. The Operator entry (317) retains the remainder of pool for the payment of fees, operations and profit. The Total field (318) should preferably add up to 100% or an error message will preferably be generated instructing the user to correct the percentage allocations. A Pool Summary (321) is generated as the pool is defined by the options on this page. The Pool Type (322), Pick Type (324), event Display (326), Quick Pick (328), Initial Pool Size (330) and Ticket Price (332) are all summarized, as is the Pool Distribution (340) including: the Pools Seed (342), Progressive (344), Operator (346) and Pool Total (349). The user may then have the option of canceling the program (319) to return to a previous page or Continuing (320) to further complete the Pool Definition.

FIG. 3B is a diagram depicting the Multi-Venue administration application defining a Multi-Venue Wager, in accordance with the embodiment shown in FIG. 3A. In this example, the Pool Type is selected from a drop down menu (302) where Any (303) has been highlighted as the selection. A Pick 5 Pool is selected by selecting the Pick Type from the drop down menu (304) where the number “5” (305) has been highlighted for selection. The ability for a user to select a Quick Pick is specified by highlighting the Yes (309) for the drop down menu (308). The Initial Pool Size (309) has been set to $70 by manual entry in that field (310). The Ticket Price (311) is set at $10 by manual entry in field (312). Pool Distribution (313) with the amount set for Prizes (314) is defined as 65% allocated towards the subsequent pool in Pool Seed (315). An additional 10% is allocated to the current progressive pool (316). The Operator will retain earnings of 25% and the correct total (318) is reflected as 100% in field (318). The Pool Summary (321) displays the details of the Pool in accordance to the definitions selected or input. The Pool Type (322) is an Any Pool (323); the Pool Type (324) is a Pick 5 (325). The user will be displayed (326) all sequential events (327); the Initial Pool Size (330) is $70 (331) and the Ticket Price (332) is $10 (333). The Pool Distribution (340) is summarized to be 65% (343) towards the subsequent Pool Seed (342) with 10% (345) allocated towards the current Progressive (344). The Operator's (346) retention is 25% (347) and the Total (349) 100% (349). Once the pool has been fully defined by selecting the participating racetrack venues as shown in FIG. 3C, FIG. 3D and FIG. 3E, the Operator may either Cancel the process or submit the pool for display as an active wager. Upon submission, the system assigns a Pool Number (not shown) to the Pool. At this point the user may Cancel the process (319) or Continue (320) and further define the Pool elements.

FIG. 3C is a diagram depicting the entry of racetrack fees (Host Fees) which will be used to calculate the amount of fees which will be paid to the participating venues. Each track may have a different fee. The Operator will access an application facilitating the input of Host Fees (351). For each venue, the Operator accesses a drop down menu (352) containing several fee selections as well as an “Other” selection. The Operator may select any of the drop down items or use the “Other” selection to input an amount not found in the drop down menu. The Operator enters the Host Fee for each racetrack (353). At this point the user may Cancel the process (319) or Continue (320) and further define the Pool elements.

FIG. 3D is an example of Host Fee calculations performed by the system based on the fee schedule previously defined. Host Fees are tracked by the Pool Number (361). The Price Per Ticket (362) is used to define the Fee Base per Selection (363). Since no actual wagers are placed in the participating venues pool at the racetrack, a Fee Base is used to calculate how much would have been placed in the pool for each selection made. In this example, since the ticket price is $10.00 and there are 5 selections in the ticket the Fee Base Per Selection is $2.00. The Total Tickets Sold (364) and the Total Selections (365) based on the Total Tickets is displayed. Each venues Host Fee (366) is multiplied times the Fee Base (368) to determine the fee per selection (not shown). The Fee per Selection is multiplied times the Total Selections (367) to determine the Total Fees (369). FIG. 3E is a diagram depicting the same process using a $2 ticket as an example.

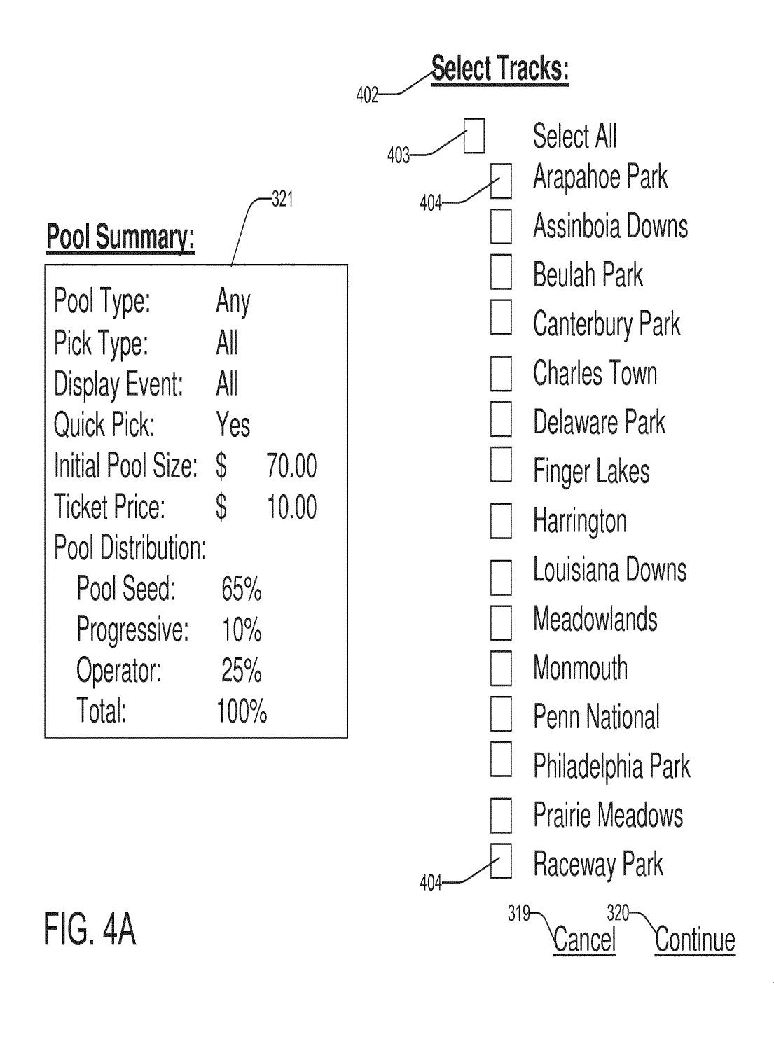

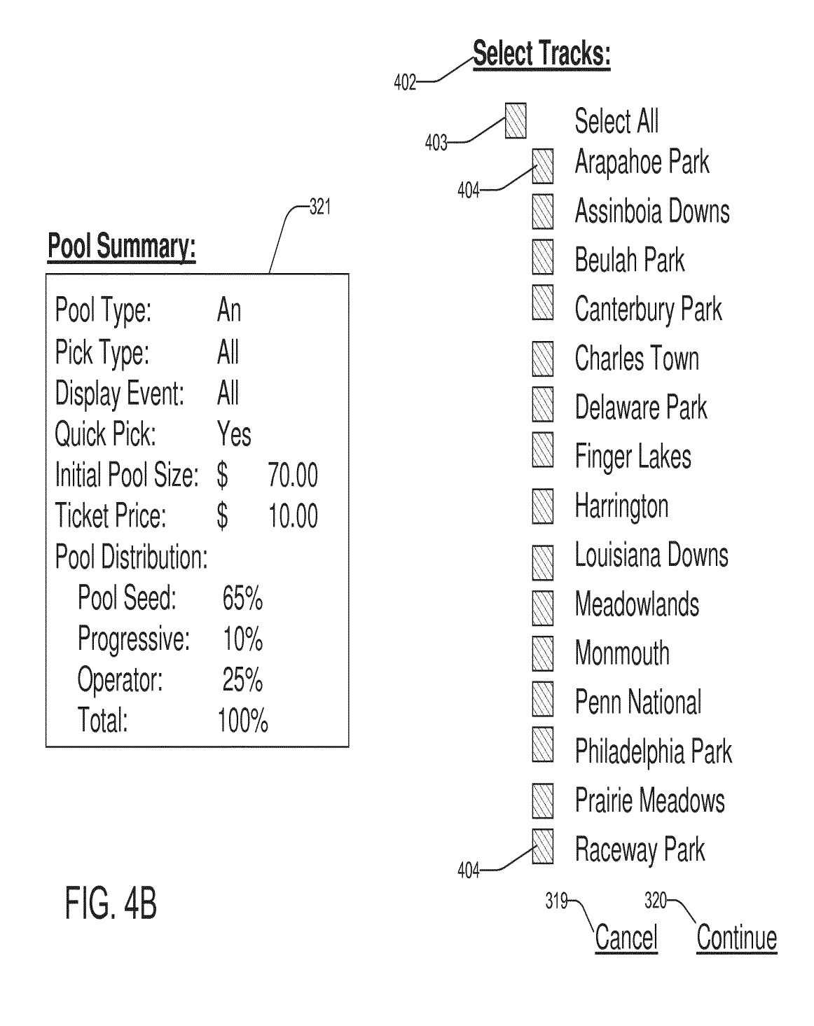

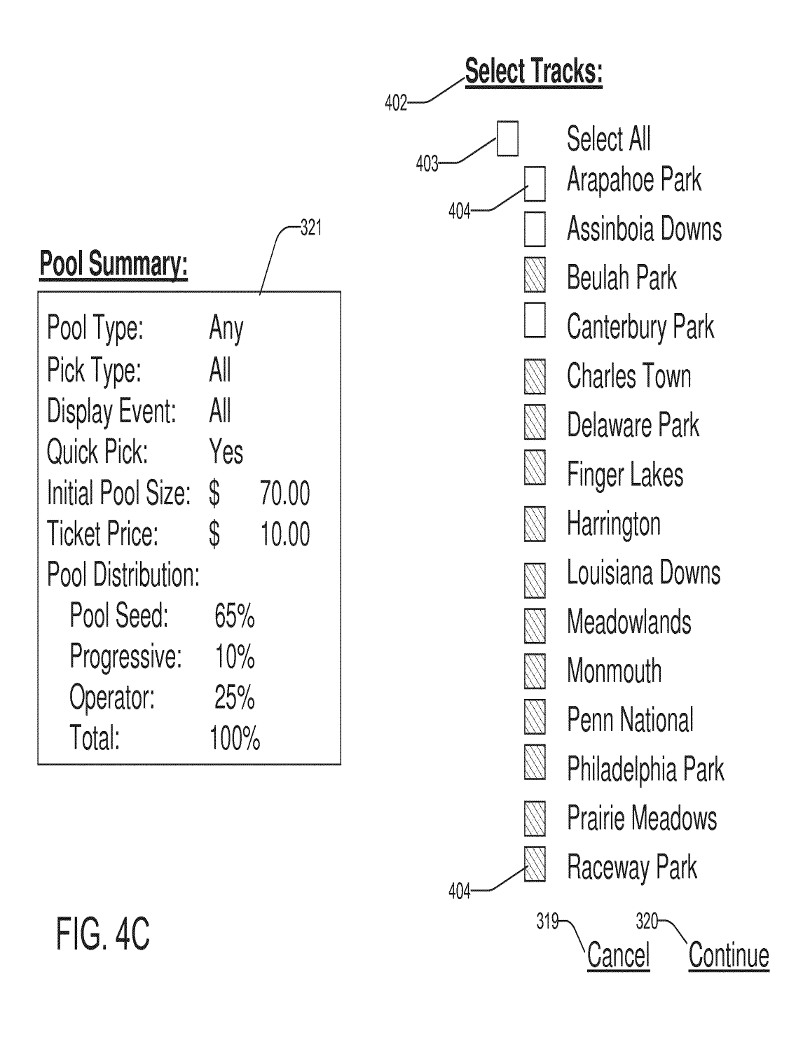

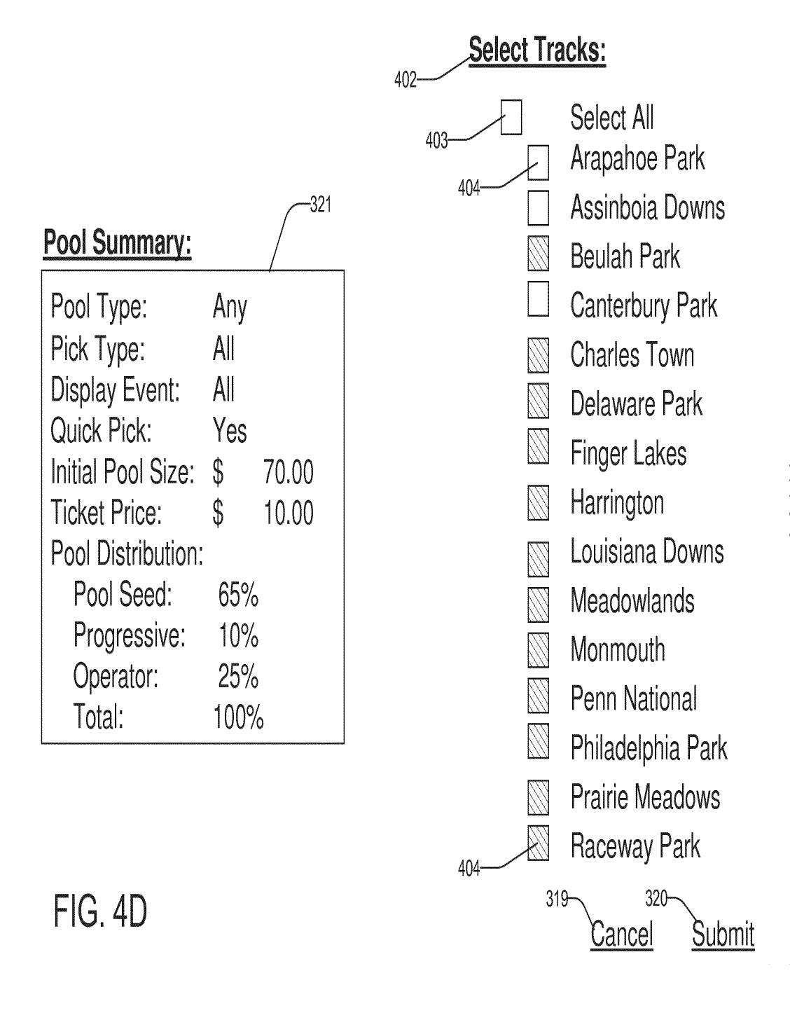

FIG. 4A is a diagram further depicting the Multi-Venue administration application for the setup of a Multi-Venue Wager whereby a selection is offered from a plurality of venues, in accordance with the embodiment shown in FIGS. 3A and 3B. FIG. 4A depicts the track selection that will define which venues will participate m the defined Pool. A Pool Summary (321) is displayed depicting the definition of the pool thus far in the process. A Track Selection (402) is generated from the tote (101) interface. A User may elect to Select All venues (403) or select individual venues by clicking on the field associated with the venue (404). As with previous screens, the user is given the ability to Cancel the process (319) or Continue (320).

FIG. 4 B is a diagram further depicting the Multi-Venue administration application for the setup of a Multi-Venue Wager whereby a selection is made from a plurality of venues utilizing a “Select All” function (403). FIG. 4B depicts the user interface for venue selections whereby the Pool Summary (321) is displayed and the available venues are displayed under the Select Tracks (402) section of the page. In this example, all of the venues have been selected by highlighting the Select All field (403). Correspondingly, all of the venues (404) have been automatically highlighted as selections. As with previous screens the user is given the ability to Cancel the process (319) or Continue (320).

FIG. 4C is a diagram further depicting the Multi-Venue administration application for the setup of a Multi-Venue Wager whereby a selection is made from a plurality of venues on an individual basis. This FIGURE depicts a user interface for venue selections whereby the Pool Summary (321) is displayed and the available venues are displayed under the Select Tracks (402) section of the page. In this example, individual venues have been selected by leaving the Select All field (403) blank. Each individual venue (404) is manually selected and highlighted as a selection available for the Multi-Venue Wager. As with previous screens the user is given the ability to Cancel the process (319) or Continue (320).

FIG. 4D is a diagram further depicting the Multi-Venue administration application for the submission of a Multi-Venue Wager for display and processing by the MultiVenue application system. FIG. 4d depicts a user interface for Wager Review is offered prior to submission. The Pool Summary (321) is displayed and the available venues are displayed under the Select Tracks (402) section of the page. In this example, individual venues have been selected by leaving the Select All field (403) blank. Each individual venue (404) has been manually selected and highlighted as a selection available for the Multi-Venue Wager. As this is the final stage of the Wager definition process, the user is given the ability to Cancel the process (319) or Submit the Wager to be posted (320).

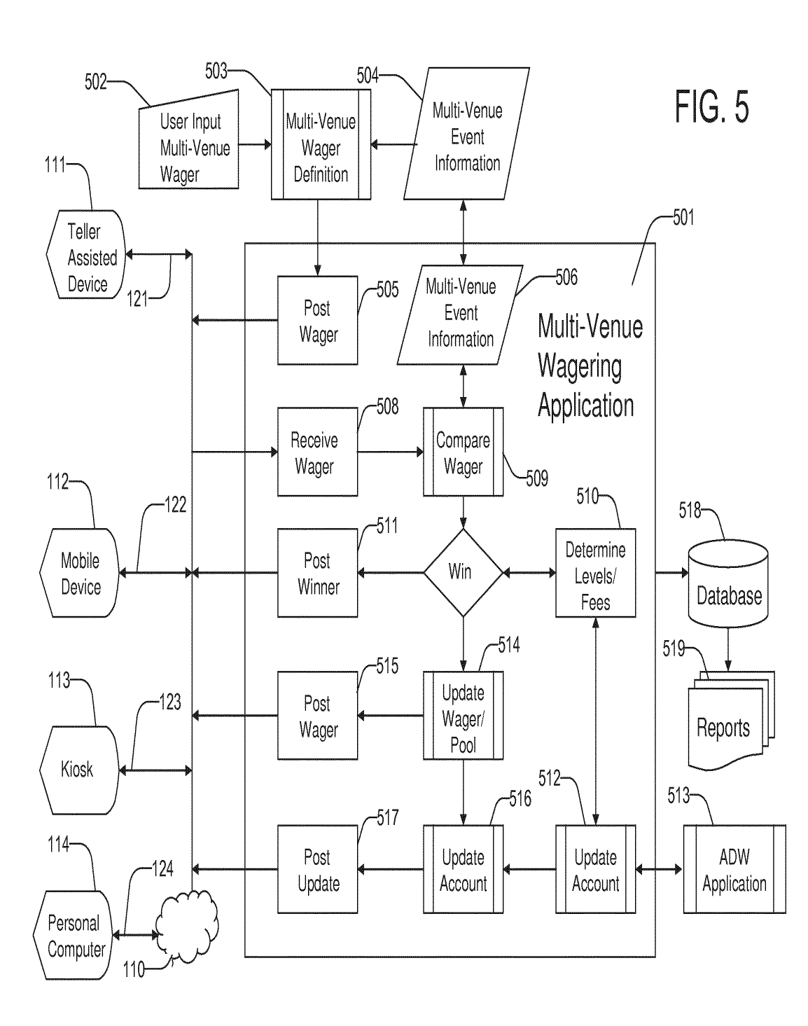

FIG. 5 is a flowchart depicting the process by which a Multi-Venue Wager is defined and processed, in accordance with one embodiment of the present invention. The MultiVenue Wagering Application (501) provides all of the processing functions of the Multi-Venue Wager from definition through payment of winnings and fees. As previously described, an administrator may use an input device (502) such as a keyboard and monitor to access the adjunct applications for Multi-Venue Wager Definition (503). Multi-Venue Event information (506) is received from the previously described tote interface and kept in constant communication with the MVWA (501). The Wager defined in the Multi-Venue Wager Definition (503) is Posted within the application (505) and transmitted through a plurality of interfaces (121, 122, 123, 124) including the Internet (110). Devices such as Teller Assisted Devices (111), Mobile Devices (112), Kiosks (113) and Personal Computers (114) may interactively display the Wager and its components. These devices transmit the wager to the MVW A (501) where it is received by the Applications (508) where the predicted results are compared to the actual results (509) utilizing the Multi-Venue Event Information (506) supplied from the tote. If there are one or more winning entries, the system will determine the current pool amount and the distribution of the pool to the one or more winning entries. The winning entries are Posted (511) in the Application and transmitted to the previously described devices. Fees due to participating racetrack venues are calculated for payment (510). A new wager may be automatically posted through the definition of the subsequent seed amount as defined in MultiVenue Wager Definition (503) and the process is restarted. Winners may claim the proceeds from the wager depending on the device used to place the wager. If the one or more winning entries are account based, the account is updated (512) and the ADW Application (513) is accessed in order to update the account as per the Winning entry. If there are no winning entries in a defined pool, a new pool is posted based on the next subsequent event as received from the Multi-Venue Event Information (506) and seeded with the then current amount of the previous Pool. The updated wager and Pool (514) is defined and Posted (515) to be made available to the interactive devices. As previously described for winning entries, losing entries utilizing account based transactions have their accounts updated (516) through communications with the ADW Application (513) and are then posted (517) for distribution to account based interactive devices. All information relating to the definition and processing of wagers, including the receipt, comparison and payment of winnings and fees are recorded in a database (518) for future reporting requirements (519).

FIG. 6A is diagram shown an example of a Pick 5, Play Any Event, Multi-Venue Wager display, in accordance with one embodiment of the present invention. It should be noted that Pool Information and Ticket Price is not shown in this, or the following examples. In this embodiment, the Display (601) is comprised of 25 separate events/wagers arranged in a 5×5 grid of squares. Each square in the display depicts a specific wagering opportunity based upon the favorite runner (e.g. horse) to win their event. As previously described, this has been defined (302) as Play Any Event Wager (303), and the display (306) has been set to All (307), therefore each wager related to the event is displayed. For each favorite runner in a race, the corresponding Win (611), Place (612), and Show (613) selections are shown. In example selection (615) for Monticello Race 9 displays: the race number (619); the minutes to post (616) or start; the runner (e.g. horse) name (617); and the selection type (618): $2 to Place. In this example, races are ordered by time and Win/Place/Show, in rows, starting at the top left corner, which in this example shows here Finger Lakes Race 6 Runner #1 to Win (621), Place (622), or Show (623) starting in 17 minutes, down to the lower right corner, which displays here Yavapi Downs Race 1 Runner #7 to Win starting in 61 minutes (631). The configuration shown in FIGS. 6A-6F is exemplary. Displays with other numbers of boxes for races or picks than 25 are within the scope of the present invention, as are other arrangements of boxes within the display.

The player can then make his selection by clicking on each box. Players may then handicap their picks and make individual selections based upon their expertise. In a Pick 5 game, the player could pick five picks or wagers. Alternatively, since each runner is a favorite, novice players may simply select a Quick Pick (604) that will randomly select 5 selections for them. An “All Down” variation of the Quick Pick automatically highlights the 5 vertical selections directly below the All Down button (606). Correspondingly, an “All Across” option (608) may be available that will automatically highlight the 5 horizontal picks associated with it. At any time during the process the user may select to clear the selections (602) and start over. Once satisfied with the selections made, the player can place the wager by clicking on the Submit Selection button (603). Note for future reference that Delaware Park, Race 6 (631-633) is the next sequential race after Finger Lakes, Race 6 (621-623) and that the Yavapai Downs, Race 1, Win selection (641) is the last event on this Multi-Venue Wager.

FIG. 6B is a diagram showing additional information available to the player from the racing venue information shown in FIG. 6A. To view additional information the player simply places the cursor over the runner number in one of the cells. This is commonly referred to as hovering over a field. Other methods are also within the scope of the present invention. For the Monticello (615), Race 9 (619), $2 Place selection (618), the hover action causes the display of additional Runner Details (650). Other methods of displaying these details are also within the scope of this invention. These details may include the Runner's Name (654), Runner Number (655), Odds (656), Colors (657), Jockey Name (658), weight (659), and owner (653). The Odds (656) may be predetermined to be morning line, odds when a pool opened, current odds, or odds at some other predefined time. The colors associated with a runner, commonly referred to as silks may be displayed (657), as may be the Jockey's Name (658) and the Jockey's Weight (659). The Owner's Name (653) may also be furnished, along with his home. Other information may be available for display and is left to the discretion of the operator to decide what information is displayed.

FIG. 6C is a diagram showing an exemplary depiction of an “All Across” selection where the “All Across” (608) button associated with the 3rd horizontal row has been selected. In this example, the player has relied upon the system to highlight: Fort Erie, Race 6, $2 Place (661) and Show (662), in addition to Finger Lakes, Race 7, Win (663), Place (664) and Show (665). Upon selection, the “All Across” button (608) may change to “Undo All Across” (609) providing the player with a simple method for clearing the selection and starting over. Alternatively the user may simply press the “Clear Selection” button (602). In one embodiment of the present invention, the selected wagers (661-665) and the “Undo All Across” button (609) are highlighted by, for example, changing color, indicated in this FIGURE by being shaded. When the player is satisfied with their selection, the “Submit Selection” button (603) may be pressed and the wager may be submitted for confirmation and processing.

FIG. 6D is a diagram showing an exemplary depiction of an “All Down” selection where the “All Down” (606) button associated with the 4th vertical column has been selected. In this example, the player has relied upon the system to highlight: Delaware Park, Race 6, $2 Win (671); Monticello, Race 8, $2 Show (672); Finger Lakes, Race 7, $2 Place (673); Delaware Park, Race 7, $2 Place (674); and Fort Erie, Race 6, $2 Show (675). Upon selection, the “All down” button (606) may change to “Undo All Across” (609), providing the user with a simple method for clearing the selection and starting over. Alternatively the player may simply press the “Clear Selection” button (602). In one embodiment of the present invention, the selected wagers (671-675) and the “Undo All Down” button (607) are highlighted by, for example, changing color, indicated in this FIGURE by being shaded. When the player is satisfied with their selection, the “Submit Selection” button (603) may be pressed and the wager is submitted for confirmation and processing.

FIG. 6E is a diagram showing an exemplary depiction of a “Quick Pick” selection where the “Quick Pick” (604) button has been selected. In this example, the player has relied upon the system to highlight: Finger Lakes, Race 6, $2 Win (681); Monticello, Race 8, $2 Win (682); Fort Erie, Race 6, $2 Show (683); Delaware Park, Race 7, $2 Win (684); and Yavapai Downs, Race 1, $2 Win (685). Upon selection, the “Quick Pick” button (604) may change to “Undo Quick Pick” (605) providing the user with a simple method for clearing the selection and starting over. Alternatively the player may simply press the “Clear Selection” button (602). In one embodiment of the present invention, the selected wagers (681-685) and the “Undo Quick Pick” button (605) are highlighted by, for example, changing color, indicated in FIG. 6E by being shaded. When the player is satisfied with their selection, the “Submit Selection” button (603) may be pressed and the wager is submitted for confirmation and processing.

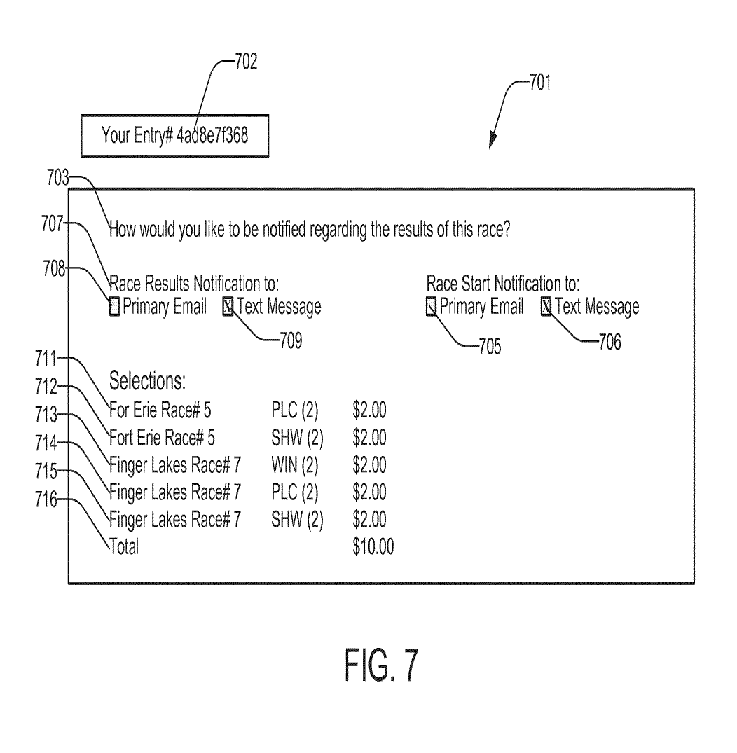

FIG. 7 is a diagram showing an exemplary wager confirmation, in accordance to the wager placed in FIG. 6C. The wager confirmation (701) is provided after the system has verified that all entry selections are valid in the tote system and an entry number is given (702). In this example the player may elect to be notified (703) for each entry of the Race Start (704) by either email (705) and/or Text Message (706). Correspondingly, the player may request the results of each selection (707) be sent to him by either email (708) and/or Text Message (709). Each selection in his wager is displayed: Fort Erie, Race 6, $2 Place (711) and Show (712) in addition to Finger Lakes, Race 7, Win (713), Place (714) and Show (715) for a total of $10.00 (716).

FIG. 6F is a diagram showing an exemplary subsequent Pick 5 Wager, in accordance with the example shown in FIG. 6A, assuming that there were no winning entries in the previous pool. The seed amount of the new pool would be the amount unclaimed from the previous pool (not shown). Note that in the new pool, Delaware Park, Race 6 (631-633), previously the second set of selections of the preceding pool, is now the first set of selections of the new pool. As the next sequential event, the new pool began 4 minutes following the conclusion of the first race of the preceding pool. Yavapai Downs, Race 1, $2 Win (641) remains the last event of the preceding pool while Yavapai Downs Race 1 $2 Place (642) and Show (643) have been added to the new pool and Monticello, Race 10, $2 Win (651) is now the last event of the new pool.

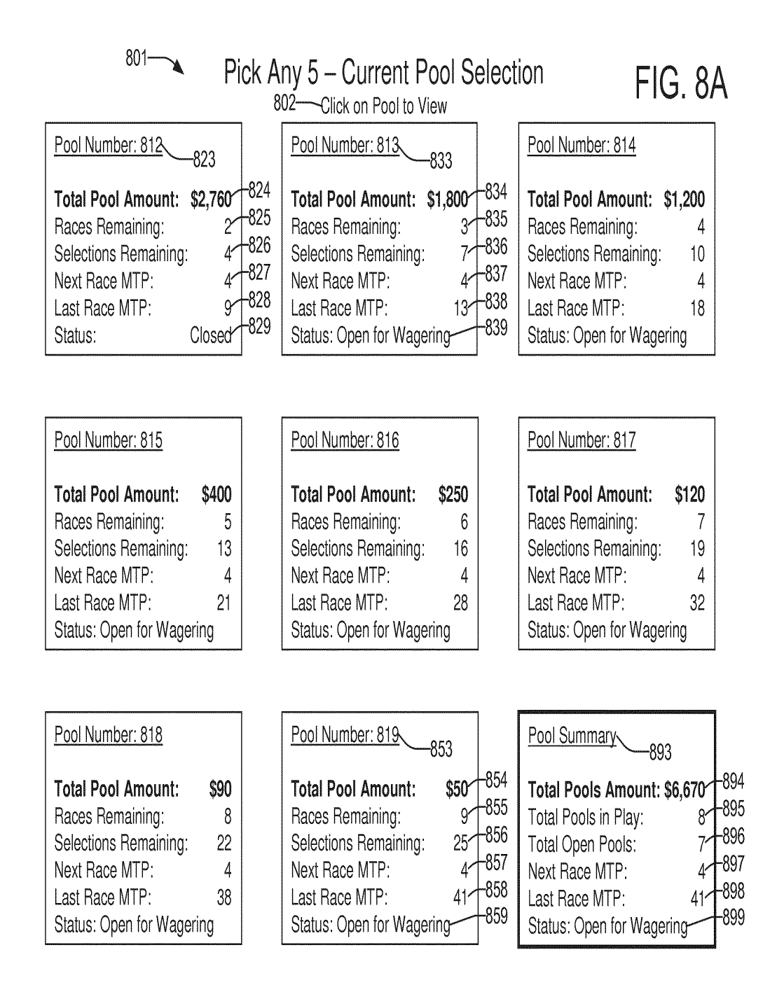

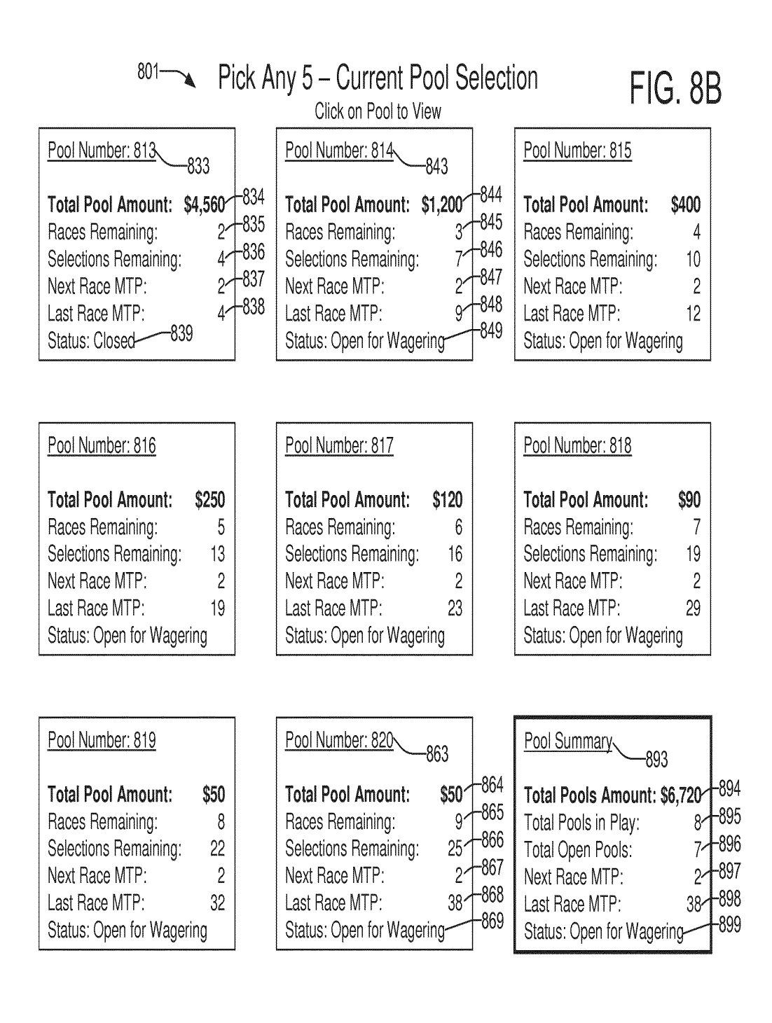

FIG. 8A is a diagram showing an example of a concurrent pool display depicting the sequential and progressive nature of the pools, in accordance with one embodiment of the present invention. It shows an example of a Pick Any 5 Pool Selection display (801). In this display, the user is instructed to click on any pool (802) to display the pool selections. There are eight pools shown (812-819). For each pool a summary is given in the Pool Selection. For example, in Pool 812 (823) the total amount of the pool is $2,760 (824); there are 2 races remaining (825) with four selections (826). The reason that there are 2 Races Remaining but 4 Selections, is that since the pool is a grid of 25 boxes and there are 3 wager possibilities in for each event, the first 8 events (24 wager possibilities) are shown plus the next wagering possibility of the next race. Therefore, there are 8 races with Win, Place, and Show and 1 race with a Win only bet for a total of 25 wagering possibilities. The minutes to post (MTP) or start time for the next race shows how much time is left until the next race starts. In this case the Next Race MTP is 4 minutes (827). The last race in this pool will start in 9 minutes (828). Since there are not enough selections left in this pool to place a wager, the Status (829) of the pool is “Closer!”. Pool number 813 (833) shows that there is a Total Pool Amount of $1,800 (834) and three Races Remaining (835) and a total of 7 Selections Remaining (836). Since this pool (813) shares the same common first event as Pool Number 812, the Next Race MTP (837) is also 4 minutes. In this example, another race has been added, and the Last Race MTP (838) is now 13. Since there are 7 selections remaining, the Pool Status (839) is “Open for Wagering”. Pool Number 819 (853) is the final concurrent Pool in sequence. This pool reflects a Total Pool Amount (854) of $50, the initial pool seed amount in this example. There are a total of 9 Races Remaining (855), consisting of 8 races with Win, Place and Show (24 wagering selections) and 1 race with a Win selection for a total of 25 Selections (856). As with Pool Number 813, the Next Race MTP (857) is the same as Pool 812, with 4 minutes remaining until the next race. The Last Race in this Pool (858) has 42 minutes to post (start) time, and the Status (859) is “Open for Wagering”. The Pool Summary (893) shows the data for total concurrent pools in play. Assuming that there were no winners and no further wagers, the Total Pools Amount (894) is $6,670. This is the aggregate of all of 8 Total Pools in Play (895), of which there are 7 Total Open Pools (896). The Next Race MTP (897) and the Last Race MTP (898) are consistent with the last pool in play, Pool Number 819, and since there is at least 1 pool open for wagering, the Status (899) is “Open”.

FIG. 8B is a diagram that further exemplifies the sequential nature of the pools depicting the addition of a new pool (820) upon the completion of the last race of the previous pool (812) as shown in FIG. 8A. For simplicity, this example assumes that there were no winners and that no additional wagers have been place. Once the final race in Pool 812 (FIG. 8A) has been run, Pool Number 813 (833) becomes the next successive pool. The Total Pool Amount (834) reflects the amount in Pool 812 ($2,760) carried over and added to Pool Number 813 ($1,800) for a total of $4,560. As is consistent with FIG. 8A, there are 2 Races Remaining (835) and 4 Selections Remaining (836). The Next Race MTP (837) is 2 minutes and the Last Race MTP (838) is 4 minutes. Since there are only 4 Selections Remaining, and not enough selections to place a wager, the pool is closed (839). Pool Number 814 (843) now becomes the second pool in sequence, with a Total Pool Amount (844) of $1,200, 3 Races Remaining (845), and 7 Selections Remaining (846). The Next Race MTP (847) is consistent with Pool Number 813 at 2 minutes and the Last Race MTP (848) has advanced from 18 to 9 minutes; the difference being the 9 Minutes to Post for the Last Race MTP as shown in FIG. 8A for Pool Number 812. The Status (849) of this pool remains “Open for Wagering”. Pool Number 820 (863) is the new pool which was created when the last race of Pool 812 was finished. The Total Pool Amount (864) reflects the initial pool seed amount consistent in FIG. 8A of $50. As in Pool 819 in FIG. 8A, this pool has 9 Races Remaining (865) and 25 Selections Remaining (866). Consistent with Pool Number 813, the first pool in sequence, the Next Race MTP (867) is 2 minutes. However, since this pool adds a new event to the sequence of events, the new Last Race MTP (868) reflects that event and is displayed at 38 minutes and the Status (869) is “Open for Wagering”. The Pool Summary (893) reflects the current Total Pools Amount (894), now $6,270, after the addition of the new pool (820). As previously described, the Total Pools is Play (895) remains 8, the Total Open Pools (896) is still 7. The Next Race MTP (897) is consistent with Pool 813 and all of the pools in this sequence and there are 38 minutes for the Last Race MTP (898). Since there is at least 1 pool open for wagering, the Status (899) is “Open for Wagering”.

FIGS. 9A, 9B, and 9C show exemplary calculations of payout odds for Pick 4 (FIG. 9A), Pick 5 (FIG. 9B), and Pick 6 (FIG. 9C), in accordance with one embodiment of the present invention. They all assume a probability of 30.8% for picking winners, 51.2% for places, and 65.5% for shows.

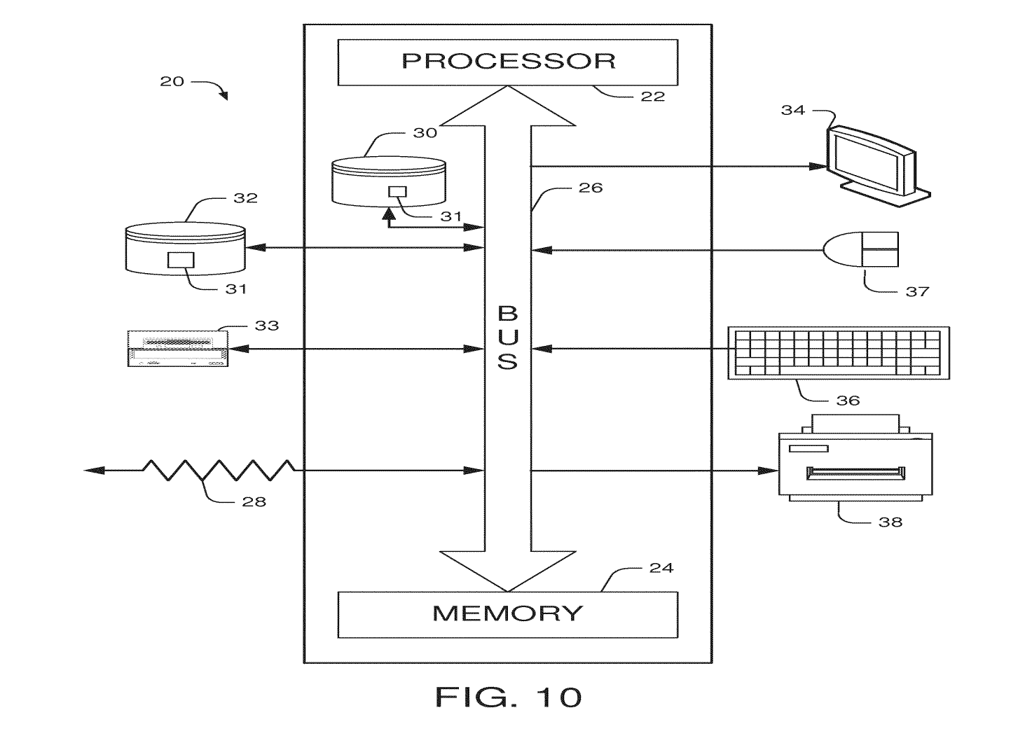

FIG. 10 is a block diagram illustrating a General Purpose Computer 20, such as utilized as servers and clients, in accordance with the present invention. The General Purpose Computer 20 has a Computer Processor 22 (CPU), and Memory 24, connected by a Bus 26. Memory 24 is a relatively high speed machine readable medium and includes Volatile Memories such as DRAM, and SRAM, and Non-Volatile Memories such as ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such operating systems, utilities, user programs, and software to accept wagers and determine winnings can be stored in a Computer Software Storage Medium, such as memory 24, Secondary Storage 30, and External Storage 32. Executable versions of computer software 33, such as defragmentation software and operating systems can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

In some embodiments, the present technology may be used to provide a random number generator based bingo or other game. The advantages of using the present technology for a bingo application in the manner disclosed herein include larger payouts based on the pooling of individual wagers into a single pool, progressive pools and the ability to play multiple cards based on these multiple pools.

In one aspect, the present system provides a method for defining a secondary game utilizing a single random Number Generator. The method includes the steps of identifying a variable number of sequential race events; defining the wager by specifying a fixed number of successful predictive outcomes required to compose the pool; specifying a correlation between a predictive outcome for each race event based upon the favorite horse to win their event and secondary game play attributes; defining the pool type and play according to secondary game play attributes to ensure a minimum pool amount is available for the wager; receiving at least one wager entry; comparing the game play attributes for successful predictive outcome for each received wager entry after an actual outcome for each race event has been determined; determining a winning wager based upon secondary game play attributes and definitions; determining an amount of winnings to be awarded based upon the number of winning entries. A process of sequential substitution is disclosed in order to ensure that each card, number, image or symbol, is mapped to a successful predictive outcome without compromising the integrity of the secondary game.

The operator hosting the pool determines the secondary game which then dictates the number of events and the wager types to be offered, whose winning outcomes represent the type of pool to be won. A defined pool may be comprised of any number of events as dictated by the secondary game. The pool represents the prize money available to players based upon an entry fee or other determinant as set forth by the operator. The secondary game defines the number of event choices that are made available to the player for selection.

In the exemplary embodiments, three different types of games are illustrated. In these examples, the Sequential Event Listing is mapped to a value corresponding to a finite set of numbers or characters as defined by the secondary game. The primary importance of the Sequential Event Listing is to ensure that a favorable event is mapped to the game defined characters. In some embodiments, the Sequential Event Listing is randomized through the use of a random number generator. This provides a greater level of interest in the display of the outcomes.

In one embodiment the game of keno is described. In traditional keno Players wager by marking an “S” over the “spot” choices on a blank keno ticket form with 80 (eighty) numbered selection boxes (1 to 80). After all players successfully place their wagers, the casino draws 20 balls (numbers) at random. Each casino sets its own series of pay scale choices called “paytables”. The player is paid based on how many numbers drawn match the numbers selected on the ticket and according to the paytable selected with regard to the wager amount.

In the present technology, the outcomes of the horse races now replaces the ball draw. The number of spots on the player's card will dictate the number of outcomes required for the game. In the example of the preferred keno embodiment, 25 (twenty-five) outcomes are needed since this is a 25 (twenty-five) spot game. A random number generator is used to assign the spot values to each race. This produces a random outcome whereby races in sequential order relate to random spot values. In this example, there is a 5 (five) ball draw so the first 5 (five) sequential events will represent the ball draw.

A favorite will finish “In the Money” in approximately 67% of the racing events. Therefore, it can be anticipated that approximately 33% of the mapped events mapped will not be drawn. Additional events are added to replace the mapped outcomes of events when the favorite does not provide a successful outcome. In one embodiment, the next sequential outcome is used to replace the prior unsuccessful outcome. This has no effect on the subsequent outcomes as they are not remapped to a new value. A new outcome will be produced until such time as the number of draws has been fulfilled. Once a subsequent event outcome has been used to replace an outcome in the current game, it cannot be used as a replacement in the same game. This guarantees that event outcomes are not duplicated in the same game.

Game play is defined by the secondary game attributes and rules, not necessarily by the ranking of the actual result contained in the Sequential Event Listing. Games where the embodiments of the invention are most applicable include card games (like poker, bridge, hearts, pinochle, rummy, etc.) and tile based games (like dominoes, mahjong, etc.). In these games the outcome is based upon a defined hierarchy of symbols, not necessarily by the symbols themselves.

The poker game of Texas Hold 'em Poker is shown to illustrate a Pick-7 of 52 Pool; one possible embodiment of the Invention. In this example, the finite number of successful sequential events to define the pool is set to 52 (fifty-two); equaling the number of cards in the deck for this game. A random number generator is used, as in the previous keno game, but in this embodiment the sequential list of events is associated with a random card event. Consider the random number generator as a card shuffler. Then the shuffled cards are associated with the sequential events resulting in a shuffled deck of cards based on the outcome of a horse race. One series of events (the card deck) may be shuffled many times. This provides the operator with the ability to conduct multiple simultaneous hands using the same mapped deck, reshuffled for each hand conducted.

In Texas Hold 'em each player is dealt 2 (two) cards face down, then 5 (five) cards dealt face up according to the game rules, for a total of 7 (seven) cards. The game represents a Pick-7 of 52, pari-mutuel pool. As described above, the only requirement of the results is that they meet the predictive nature as delineated by the Event Listing to ensure the required card mapping. The winning outcome is solely based upon the game rules; in this case the rules of Texas Hold 'em.

The use of the listing of sequential events, in combination with a random number generator, and a detailed description of game play is disclosed to illustrate how parameters and game play of the game commonly known as Texas Hold 'em poker can be defined and implemented. In the exemplary embodiment, all of the rules of the game are defined in a database (number and order of cards dealt, betting protocol, winning combinations, etc.). Particular attributes of the game such as the buy in, the rake, the pool type (Pick-5, Pick-7, etc.) are also defined. The mapping attributes, in this case to a deck of 52 (fifty-two) cards, and the mapping substitution protocol for non-predictive matching events are also defined. In this case, unsuccessful events are substituted by The Multi-Venue Administration Application (MVAA) which utilizes operator input to define the game in conjunction with the mapping application to define the game rules and game play which are subsequently controlled by the Game Play Application.

Game play commences when an operator defined minimum number of players are present to participate. A list of sequential events is generated; the values of the cards are shuffled by the random number generator and assigned to the events. Each card table hosting the required number of players is allocated a separate shuffler. In this way, only one mapping of events is required to support multiple tables and/or multiple card rooms containing multiple tables. Each card that is mapped is assigned a relative value for the determination of scoring and used in determining the weighting of a combined value. A table of combined values is also maintained. The representative value reflects a card's denomination; 2-10; Ace, King, Queen, Jack. Combined values determine the hierarchy of relative values when two or more cards are combined to reflect a predetermined hierarchical value e.g. one pair, two pair, three of a kind, straight, flush, full house, etc.

In the exemplary embodiment, a “Buy-In” of $100 (one-hundred dollars) defined antes (forced contributions by all players) may be required. In this case, the “Big Blind” and “Small Blind” have been defined and are deducted from the player's account prior to the first sequential event. This initiates the start of the pool for that particular hand of poker. Cards are dealt as defined by the rules of Texas Hold 'em; two cards face down for each player (Hole cards), a series of three cars face up (“the flop”) which are community cards, the two additional single cards (“the turn” and “the river”) which are also community cards. Each player has the option to check, bet, raise or fold after each deal; i.e., betting may occur prior to the flop, “on the flop”, “on the turn”, or “on the river”. Each bet is placed in the pari-mutuel pool for distribution upon completion of the hand. The pool (often called the pot) is awarded when a player bets and all other players fold; or if two or more players remain after the final betting round, then a showdown occurs. On the showdown, each player plays the best poker hand they can make from the seven cards comprising his two hole cards and the five community cards. A player may use both of his own two hole cards, only one, or none at all, to form his final five-card hand. If the five community cards form the player's best hand, then the player is said to be playing the board and can only hope to split the pot, because every other player can also use the same five cards to construct the same hand.

If the best hand is shared by more than one player, then the pot is split equally among them, with any extra chips going to the first players after the button in clockwise order. It is common for players to have closely valued, but not identically ranked hands. Nevertheless, one must be careful in determining the best hand; if the hand involves fewer than five cards (such as two pair or three of a kind), then kickers are used to settle ties (see the second example below). The last player to bet is the first player to show his hand. The winning hand is determined by the scoring of the relative and combined values of the cards.

In another embodiment, the invention is utilized in a tournament type of setting where an entry fee is paid to play by each player. The total of all entry fees represent the jackpot (pool) that is being offered. Play during the tournament proceeds as in the exemplary embodiment.

In these embodiments, the Game Play Application is integrated with, may include, or may communicate and operate in conjunction with an Advance Deposit Wagering system (ADW), the architecture of which are well known and commonly utilized to facilitate an online wagering operation. In this case, the ADW functions to manage the pools, banking funds for the players wagering account and maintaining player, rake and operator accounts. Players may connect with the ADW through any number of communication mediums, including the Internet. Once connected the player may use funds in their ADW account for wagering. The Game Play Application tracks all transactions and ensures that money is either debited or credited to the players ADW account accordingly.

In the final example, Bingo is shown as the preferred embodiment of a game where two random number generators are used for the game. Bingo is a game of chance played with randomly drawn numbers which players match against numbers that have been pre-printed on 5×5 matrices. The matrices may be printed on paper, card stock or electronically represented and are referred to as cards. Many versions conclude the game when the first person achieves a specified pattern from the drawn numbers. A typical Bingo game utilizes the numbers 1 (one) through 75 (seventy-five). The five columns of the card are labeled ‘B’, ‘I’, ‘N’, ‘G’, and ‘0’ from left to right. The center space is usually marked “Free” or “Free Space”, and is considered automatically filled. The range of numbers that can appear on the card is normally restricted by column, with the ‘B’ column only containing numbers between 1 and 15 inclusive, the ‘I’ column containing only 16 through 30, ‘N’ containing 31 through 45, ‘G’ containing 46 through 60, and ‘0’ containing 61 through 75.

As in the previous two examples, a sequential list of events is randomized. In this case, 75 (seventy-five) events are randomized and matched to the possible letter and number combinations which essentially generate a random string of numbers which players match to their bingo cards.

A second random number generator is used to produce the game play cards which will be available for purchase, each card being unique from the other.

A Multi-Venue Administration Application is used to define game rule, game play and mapping attributes of a generic series of at least 75 (twenty-five) sequential and identified race events. Each event represents a particular wagering event in which the horse favored to win is displayed to Win, Place or Show and in this instance, is represented in a list of 75 (seventy-five) possible outcomes. The events are maintained in a computer database with each individual outcome randomly mapped to numbers or symbols that match the game play for a particular game of bingo. In this embodiment, these mapped outcomes represent the “draw” or what is also commonly referred to as the “caller's card” (as opposed to a deck of cards in the previous example). A second random number generator is used to produce electronically represented cards with a 5×5 matrice that is displayed to the user. Each of the individual locations, or “spots”, on the card represents a predetermined outcome. These outcomes reflect a subset of the draw. Each bettor purchases at least one card representing a set of 25 (twenty-five) predetermined possible outcomes displayed by the alpha numeric values associated with a Bingo card. During the set up process of the game, predetermined patterns are set by the operator. In some cases there may be a predetermined pattern that represents the primary game play, while another pattern may be used to define a secondary prize. In many cases, the one outcome is often designated as a “Free” spot whereby it is not mapped to an outcome, but may be used in conjunction with a winning pattern. The random assignment of racing events to possible outcomes ensures that the outcome of any game card cannot be predetermined by the user and therefore alter their choice of game cards. As each race is run, the system marks the spot on the player's card according to the mapping. This mark is commonly referred to as a “daub”, with the electronic marking of the card being referred to as auto-daub.

The game is concluded either when a player's card has a specified pattern which matches the successful outcome of the game as determined from the draw or all 75 balls have been drawn with 75 successful outcomes. The operator of the system defines the event outcomes (pattern) required to win a specified progressive pool. In the example provided, the operator establishes a pattern whereby the word “Bingo” is spelled out either horizontally or vertically (however any type of pattern may be defined by the operator). Although each wager entry, or card, includes predictions for a specified number of the identified race events, in this case 25 (twenty five), the total number of outcomes is 75(seventy-five). Since the spelling of the word Bingo represents picking 5 (five) correctly from a total of 75 (seventy-five) outcomes, the game is a Pick-5 of 75 variant (unlike the previous example of a Pick-7 of 52). As in the previous example, any number of simultaneous bingo games can be offered using the same event outcomes randomized in a different order.

The range of numbers that can appear on the card is normally restricted by column, with the ‘B’ column only containing numbers between 1 and 15 inclusive, the ‘I’ column containing only 16 through 30, ‘N’ containing 31 through 45, ‘G’ containing 46 through 60, and ‘0’ containing 61 through 75. In the embodiment, the previously described Free space is located in the middle of the grid and considered automatically filled. The number of all possible Bingo cards with these standard features is P(15,5)×P(15,5)×P(15,4)×P(15,5)×P(15,5)=552,446,474,061,128,648,601,600,000 or approximately 5.52×10²⁶. When an operator determined number of cards has been sold, game play commences through the announcement of the mapped value of the first successful predictive outcome. Game play continues until the pattern announced prior to the game has been matched or all 75 outcomes (ball draws) have been completed without a winner. Winnings are allocated from a wager pool based on the number of wager entries having completely matched the correct pattern. In a traditional game of Bingo, the first person to announce Bingo is declared the winner. As an electronic game, there is the possibility of simultaneous successful pattern matches. So in this situation, the prize is split between all the winning players. Alternatively, game play may continue and secondary prizes may be awarded for other patterns matched. As in the previous example, the Game Play Application tracks all transactions and ensures that money is either debited or credited to the players ADW account accordingly.

If the pool is not won at the conclusion of the draw, the amount remaining is allocated to the pool now available for the next offering of events. Either a player wins the game by matching the designated pattern or 75 (seventy-five) outcomes have been completed and all possible mappings have been drawn. If there is no winner, and 75 mapping events with successful outcomes has been reached, the game is concluded and the amount of money in the pool is rolled into the starting pool of the next game and a progressive jackpot is established. As previously described, the Game Play Application tracks all transactions and ensures that money is either debited or credited to the players ADW account accordingly.

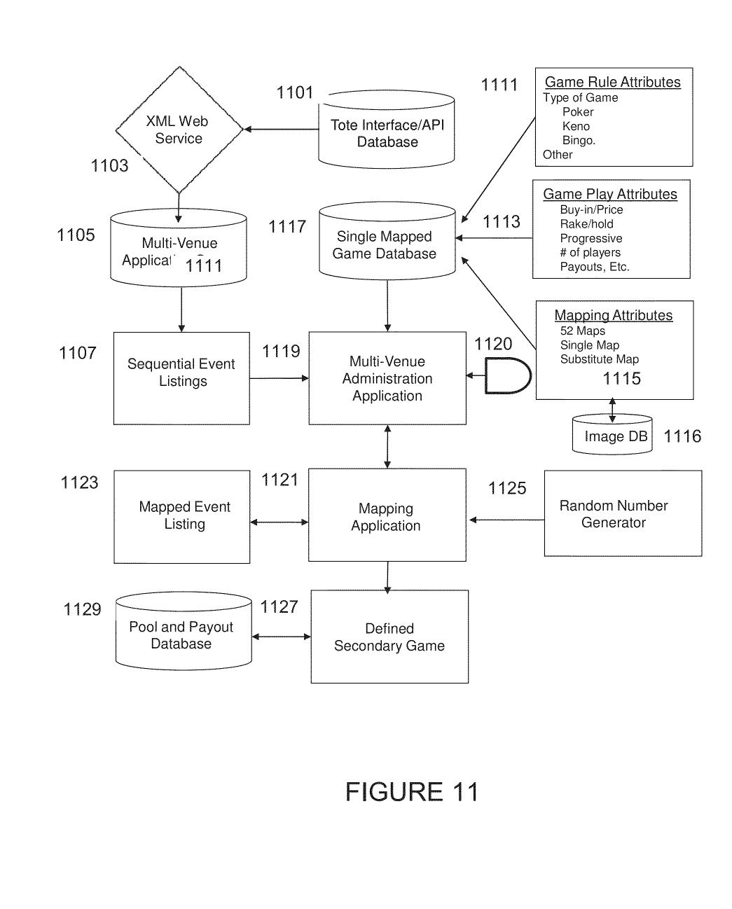

Embodiments of the present technology are now described with reference to FIGS. 11-22.

FIG. 11 is a block diagram of the system using information delivered through an XML web service. The information may be delivered from the tote for use by a Multi-Venue Administrative Application in conjunction with a single random number generator for defining a Secondary game FIG. 11 describes the functional components and flow for the Administration Application that will define the secondary game. A Tote Interface/API Database (1101) provides race information data via a communications medium (1103), an XML Web Service is used for example purposes. The information is received into a Multi-Venue Application Server (1105) where a Sequential Event Listing (1107) is produced. This output is then accessed by the Multi-Venue Administration Application (1119). The rules of the new game delineate the type of game to be played and are defined in the setup program, Game Rule Attributes (1111), while the game attributes (including rules for price, pool, payout, etc.) are laid out in the Game Play Attributes (1113) setup program. How events will be mapped are defined in the Mapping Attributes (1115) setup program which is attached to an Image Database (1116) where the administrator will associate images with outcomes. Each of these setup routines are stored in a Single Mapped Game Database (1117) which is controlled by the Multi-Venue Administration Application (1119). The administration of the Application is performed through an input device (1120) which would normally consist of a keyboard and monitor. A Mapping Application (1121) accessed through the Multi-Venue Administration Application (119) accesses the Sequential Event Listing (1107) and creates a Mapped Event Listing (1123) which then utilizes a Random Number Generator (1125) to randomize the mapped events for eventual display in the Defined Secondary Game (1127). Pool and payout information as defined by the Game Play Attributes (1113) will be contained in a separate Pool and Payout Database (1129) which will also be used to track game play by individuals for the determination of winning participants.

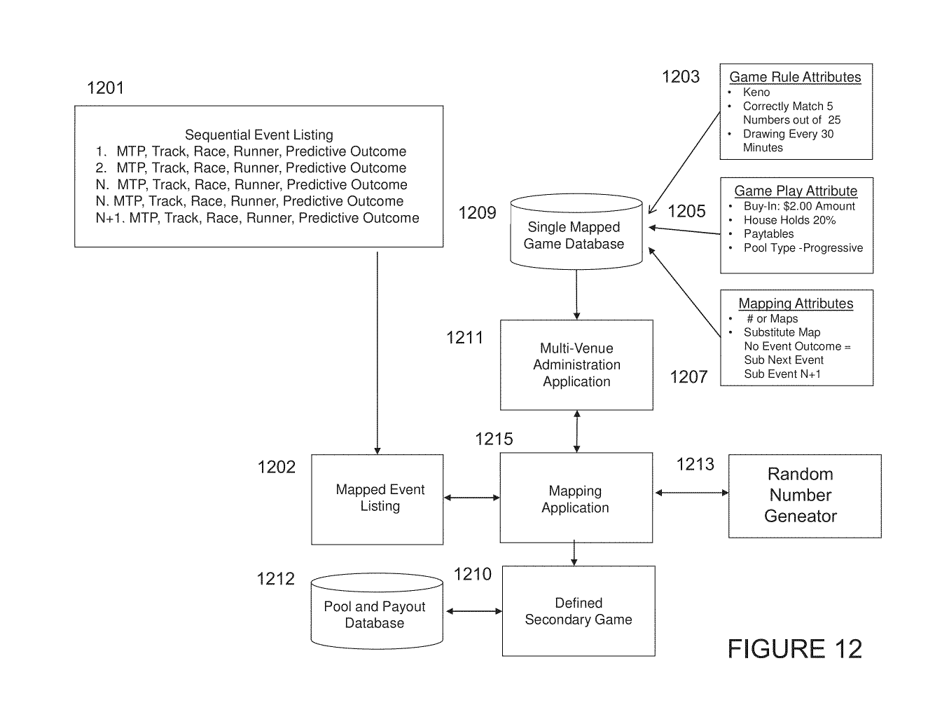

FIG. 12 is a block diagram further describing the game definition process for the game of keno. In FIG. 12, the commonly known game of Keno is defined. In this variation of Keno, the player must pick 5 (five) correct numbers from the player's card (not shown). The Sequential Event Listing (1201) has been produced and is ready to be mapped in the Mapped Event Listing (1202). The Game Rule Attributes (1203), Game Play Attributes (1205) and Mapping Attributes (1207) have all been set up for Keno. The Image Database (not shown) contains the 25 (twenty-five) numbers to be used for this game. The Single Mapped Game Database (1209) now contains all of the functional requirements needed for the Game of Keno. These have all been defined through the Multi-Venue Administration Application (1211) which will now access the Mapping Application (1215) and apply the Random Number Generator (1213) to the Mapped Event Listing (1202) to produce the Defined Secondary Game of Keno (1210). As in the FIG. 11, pool and payout information in the Pool and Payout Database (1212) will be maintained and updated; including the price of the game, the number of participants, potential payouts, results of game play etc. Once the necessary components and features of the Defined Secondary Game (1210) are in place, the Keno Game Application will be created (not shown) and the Pool and Payout Database (1212) will be linked to the Keno Game Application.

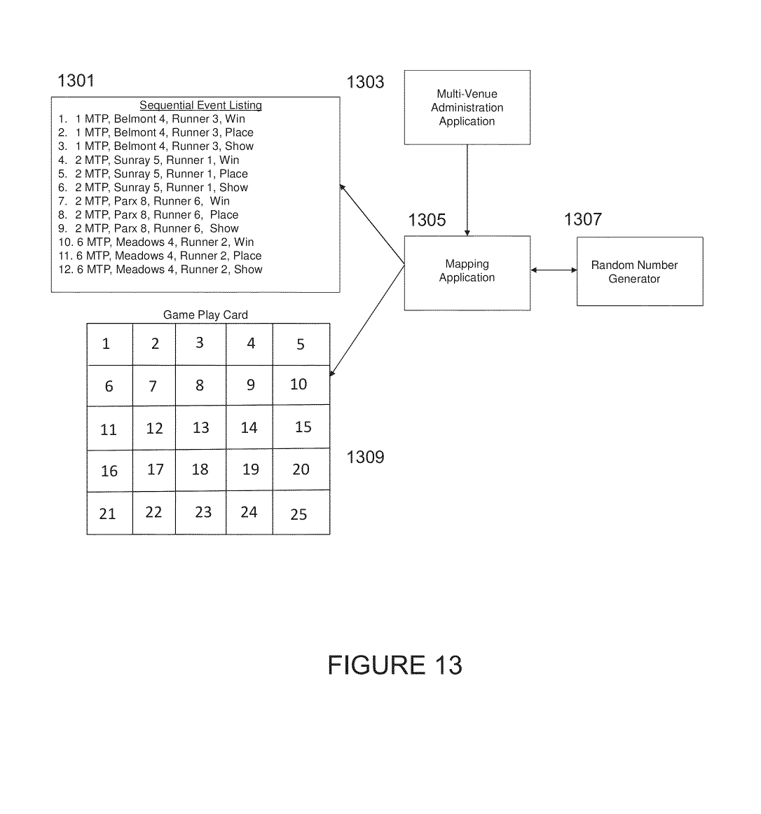

FIG. 13 is a depiction of the relationship of the Mapping Application used in conjunction with a random number generator to prior to the random number randomization of the events. This diagram depicts an intermediary step in the definition of the Keno game. The Sequential Event Listing (1301) now shows a sample of the 25 (twenty-five) events that will be used for this game. The Multi-Venue Administration Application (1303) now accesses the game Mapping Application (1305) to develop the appropriate Game Play Card (1309) as well as requesting the Random Number Generator (1307) to randomize the association between the Game Play Card (1309) and the Sequential Event Listing (1301).

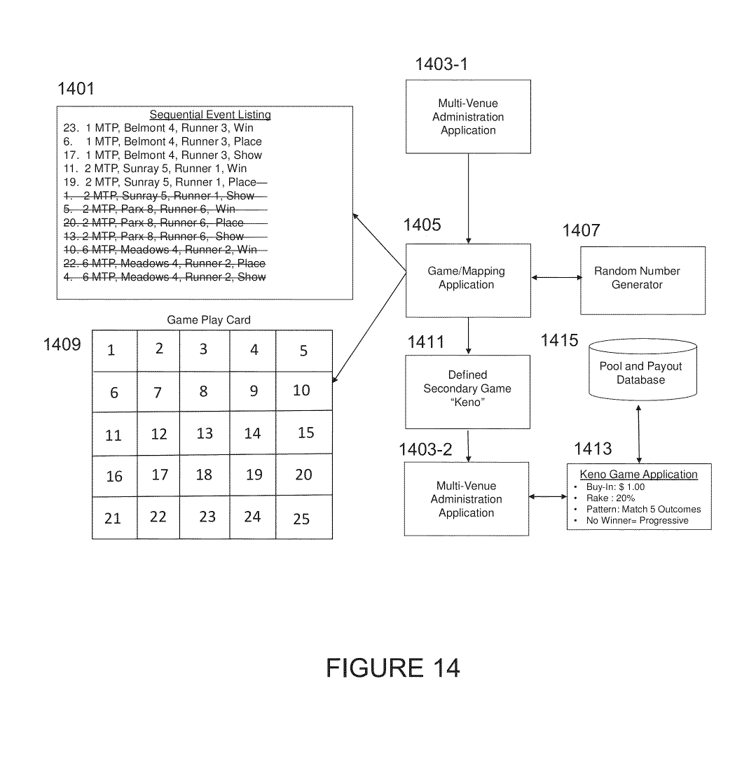

FIG. 14 is a block diagram of the game illustrating the effect of the random number generator on the sequential events, and the final ball selection to be used for the game. This diagram depicts the association between the Sequential Event Listing (1401) and the Game Play Card (1409) after the Multi-Venue Administration Application (403-1) has utilized the Random Number Generator (1407) via the Game/Mapping Application (1405) to determine the association of the winning numbers to the event outcomes used. Notice that only the first 5 (five) events have been associated with winning numbers for this game. These 5 (five) events become the results of the Keno draw. If any of these events should fail to produce a successful event, the next event in the sequential list will be substituted (not shown). The Secondary Game of Keno (1411) is now defined based on the sum of Game Attributes previously described. The Multi-Venue Administration Application (1403-1) now creates the Keno Game Application (1413). As previously described, pool and payout information for this game will be kept in the Pool and Payout Database (1415) which is now linked to the Keno Game Application (1413).

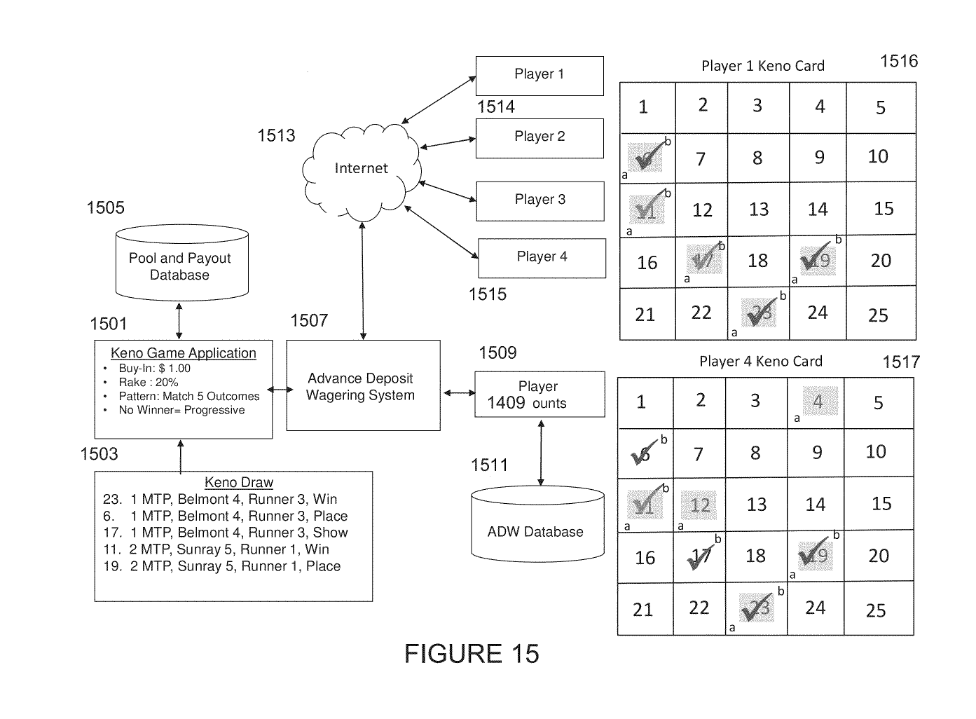

FIG. 15 depicts the Keno Game Play Application connected to an Advance Deposit Wagering System (ADW) and game play. Keno game play is illustrated in FIG. 15. Although a traditional keno game is a grid of 80 (eighty) numbers with a draw of 20 (twenty) numbers, a 25 (twenty-five) number game with a draw of 5 (five) numbers is shown for simplicity. The invention will support any number or type of keno game with multiple paytables and various payouts. In this example there is only one payout for matching 5 (five) out of 25 (twenty-five). The Keno Game Application (1501) which has previously been defined and whose winning outcomes, the Keno Draw (1503), have also been defined is offered through an Advance Deposit Wagering System (1507) operator. The Advance Deposit Wagering operator offers the Keno game for play to players whose Accounts (1509) reside in its Database (1511) via the Internet or other suitable communication medium (1513). Prior to the start of the first event, the Players (1514) and (1515) purchase Keno Cards (1516) and (1517) from an Advance Deposit Wagering System (1507) operator over the Internet (513) or other communications medium. The ADW System (1507) informs the Keno Game Application (501) of the purchases. Each player electronically marks their card (shown as a grey box (a)). This information is communicated from the ADW (1507) back to the Keno Game (1501) where the Pool and Payout Database (1505) is keeping track of card numbers and player selections. In this example, Player (1514) has selected 6, 11, 17, 19 and 23; while Player (1515) has selected 4, 11, 12, 19 and 23. Game play proceeds as the numbers are called out/drawn and electronically marked on the player's card by the Keno Game Application (1501). In this example, a red “Check Mark” (b) is used to denote which numbers have been drawn or called out. In this example, Player (1515) has a losing card, while Player (1514) has a winning card. The pool, which was determined prior to the start of the draw, is now allocated to all winning cards, less the amount as defined in the Game setup. The ADW (1507) then disperses the winnings into the winning players account (not shown) and retains the Rake in a separate account (not shown).

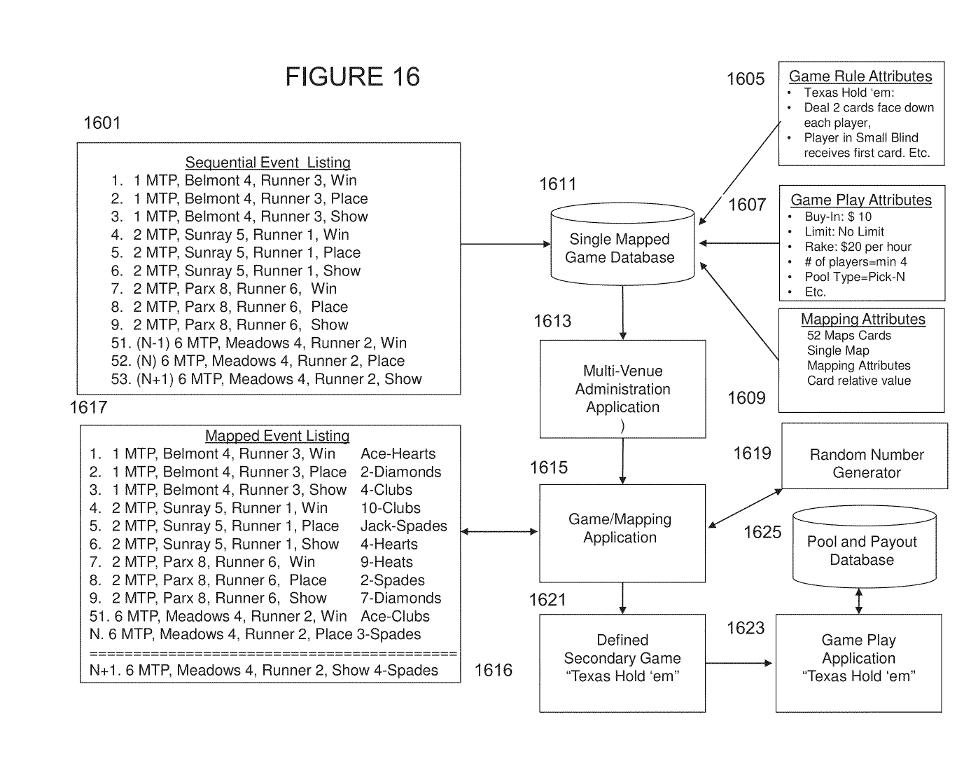

FIG. 16 is a block diagram illustrating the Multi-Venue Administrative Application Process for the creation of the game Texas Hold 'em. In another embodiment of the invention, the game of Texas Hold 'em Poker is described. In the diagram, the Sequential Event Listings (1601) have already been produced. Game Rule Attributes (1605) have been entered, as well as the Game Play Attributes (1607) and the Mapping Attributes (1609). All of these are now contained in the Single Mapped Game Database (1611) and controlled through the Multi-Venue Administration Application (1613). User input and display is through an input/output device, most likely a keyboard and monitor (not shown). As before, the Game Mapping Application (1615) will access the Random Number Generator (1619) to produce a Mapped Event Listing (617). In this embodiment, 52 (fifty-two) events will be mapped for this game of poker. Each sequential race has been mapped to a value based on a deck of cards. For example the first event, Belmont Race 4, Runner number 3 to Win is mapped to the Ace of Hearts (1617). Card number 52 is hereby referred to as “N” in the event of a substitution, then the unsuccessful event outcome will be substituted with the next available event, N+1. Any value below N, depicted by the “===” line (1616) belongs to a subsequent deck of cards, however may be used in the current deck as required for substitution. Having completed the Game Mapping Application (1615), the Secondary Game of Texas Hold 'em (1621) has been defined and the Game Play Application (1623) is created by the Multi-Venue Administration Application (not shown). The Pool and Payout Database (625) is now linked to the Game Play Application (1623).

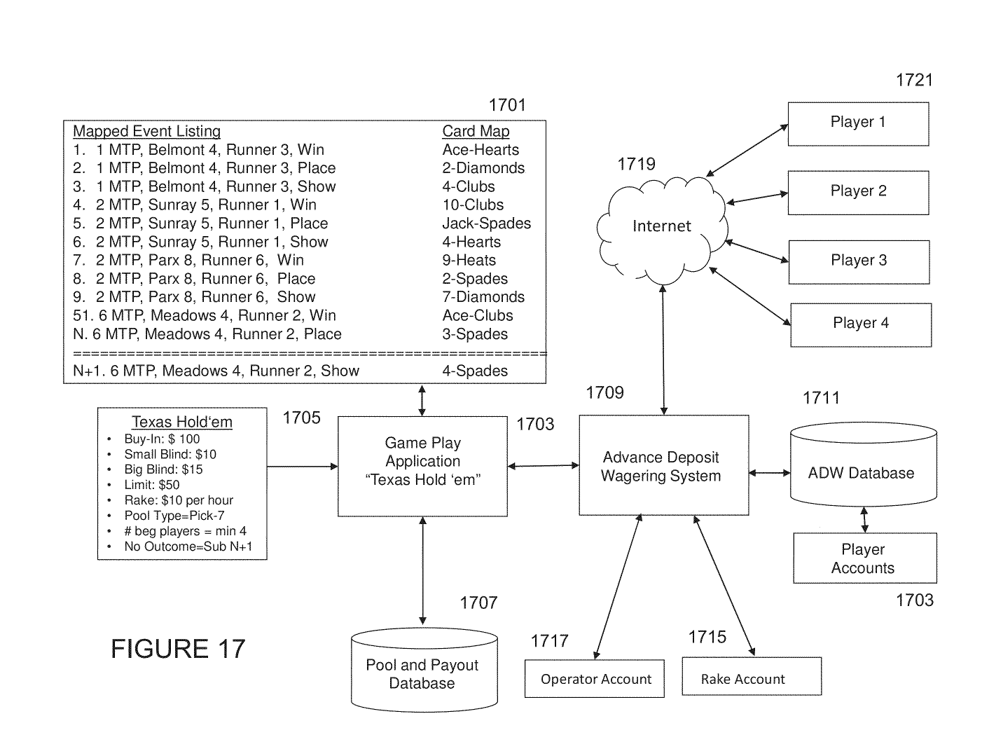

FIG. 17 is a block diagram illustrating the integration of the Texas Hold 'em Game Play Application with an Advance Deposit Wagering system operator. The mapping of events to a deck of cards is depicted in the exemplary embodiment of the poker game Texas Hold 'em. This diagram depicts the integration of the Texas Hold 'em Game Play Application (1703) with an Advance Deposit Wagering System (1709). The mapping of the deck of cards to events is shown in the Mapped Event Listing (1701). The Texas Hold 'em Game Play Application (1703) utilizes the previously set up Rules and Attributes (1705). As in the Keno embodiment, the Pool and Payout Database (1707) will track wagers, game play, fees, pools and payouts. The Advance Deposit Wagering System (1709) controls the ADW Database (1711) wherein all Player Accounts (713) are maintained. The Advance Deposit Wagering System (1709) is responsible for collecting the Rake from each player and maintaining a Rake Account (1715) where the fees for play are deposited. On a regular basis, these fees will be moved to an Operator Account (1771) via the Advance Deposit Wagering System (1709). The Rake Account (1715) will be the basis for determining how much revenue was realized as a result of the games played and revenue shared (as applicable) with the provider of the Game Play Application. Prior to the start of the first event, players (1721) ante the amount defined in the Texas Hold 'em Game Play Application (1703) to the Advance Deposit Wagering System (1709) which receives the ante information over the Internet (1719) or other communications medium. The ADW tracks the player through its system and informs the Game Play Application (1703) which in turn communicates the players and ante to the Pool and Payout Database (1707) which initiates game play tracking for this hand.

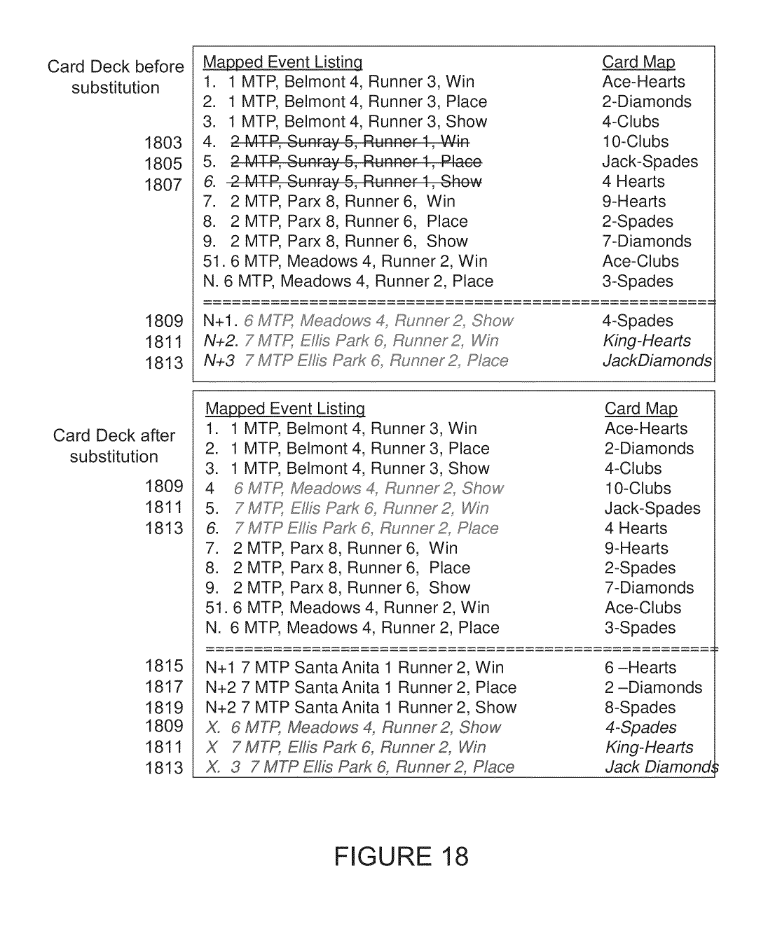

FIG. 18 is a block diagram depicting the process to ensure a successful outcome is mapped to the appropriate card value when a previously mapped event fails to produce a successful outcome. Now focusing on the effect of an unsuccessful event outcome, FIG. 18 depicts how the substitution of events transpires. This process is also utilized in the previously described Keno embodiment, the following Bingo embodiment and may be used for any other future embodiments. It facilitates the replacement of one or more events without degrading the integrity of either the current mapped events, or subsequent mapped events. In the Card Deck Before Substitution (1801) a runner has scratched or otherwise failed to produce any of the 3 (three) outcomes assigned to it; Win (1803), Place (1805) and Show (1807). In order to ensure the integrity of the deck and mapped values, new events must be substituted while preserving the mapped values. Recalling that “N” is the value of the 52nd card in the deck, N+1 (1809), N+2 (1811) and N+3 (1813) will be used for this purpose. Note that N+1 (1809) is from an entirely different track than N+2 (811) and N+3 (1813). Event outcomes may be decoupled from the physical venue, runner number or outcome. Therefore, N+1 (1809) is from Meadows Race 4, Runner Number 2 to Show and N+2 (1811) is from Ellis Park Race 6, Runner Number 2 to Win.

After Substitution (1810), the events corresponding to (1809), (1811) and (1813) have replaced the events of (1803), (1805) and (1807). Note that although the events have been substituted, they remain mapped to the original value to ensure integrity of mapping. These events still remain in the subsequent deck, with their original mapping numbers to ensure the integrity of that deck. However, since these events have been applied to the previous deck, they can no longer be used for future substitutions in that deck. They are flagged to ensure non-duplication in the current deck should another substitution be required. Now observe that the next sequential series of events has moved into the N+1 (1815), N+2 (1817) and N+3 (1819) designations. Should any further substitutions be required, these will be the next sequential replacements. This process continues until the required number of successful outcomes has been fulfilled.

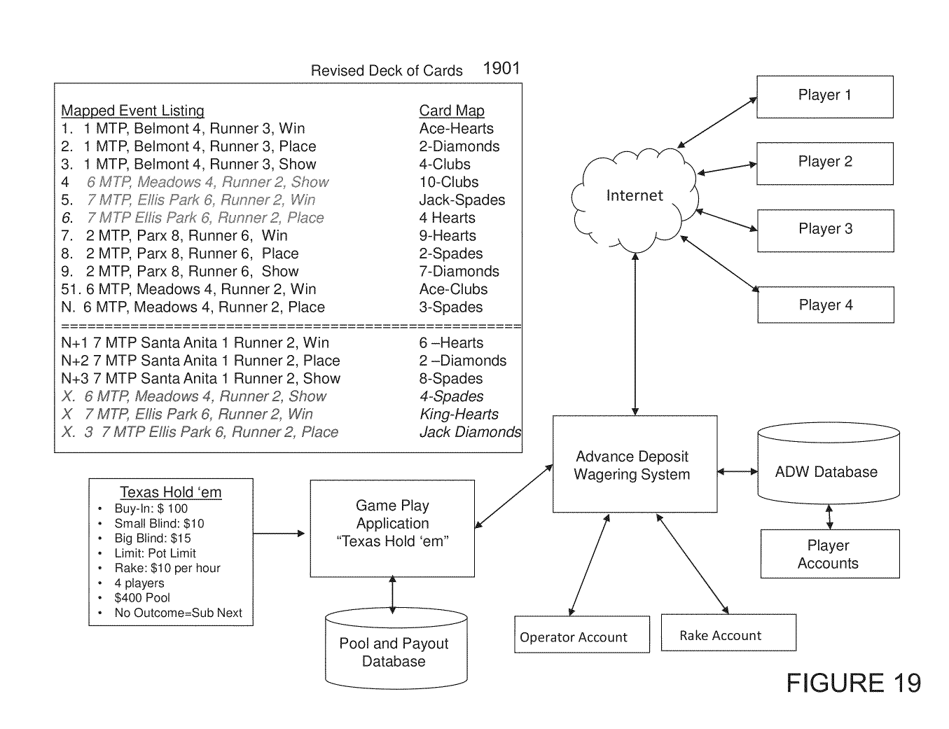

FIG. 19 is a block diagram of the deck of cards used during game play after event substitution. The integration of the Texas Hold 'em Game Play Application with an Advance Deposit Wagering System is described in FIG. 19. In FIG. 19, the Mapped Event Listing (1901) is shown after the substitution of events as described in FIG. 18. This Revised Deck of Cards (1901) is now the basis for game play. This substitution has no effect on either game play or card values. Substitution of events is transparent to the player.

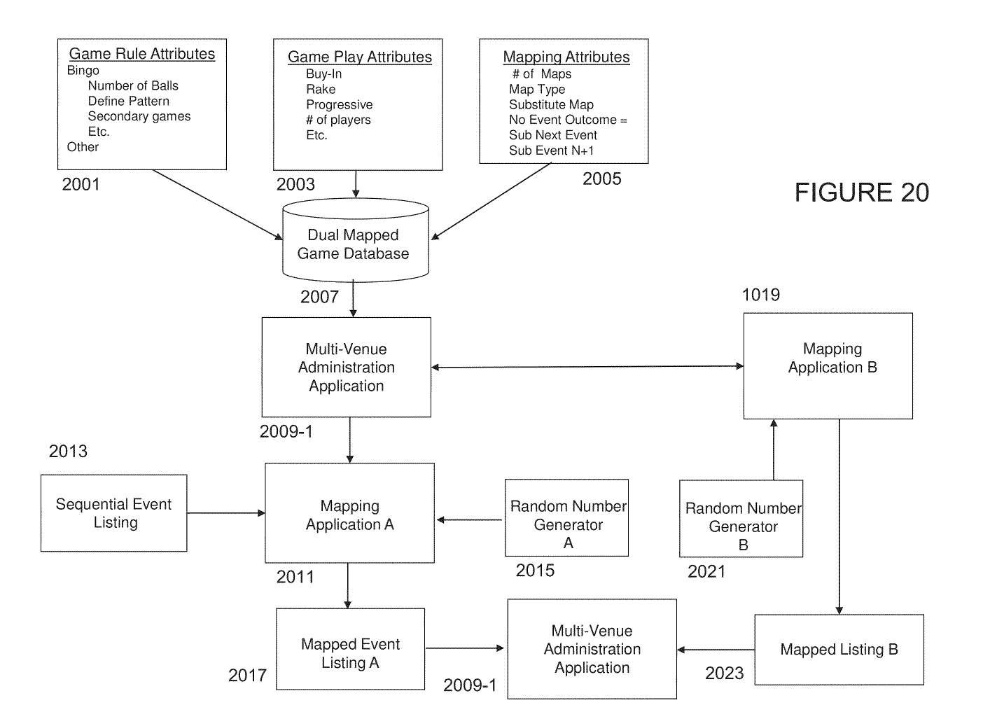

FIG. 20 is a depiction of the application of two random number generators to produce a game requiring the mapping of two separate criteria. The utilization of dual random number generators to produce both mapped events and game play cards is shown in FIG. 20. This game concept utilizes many of the same features as previously illustrated. Game Rule Attributes (2001) and Game Play Attributes (2003) have been used to define prior game embodiments. The addition of a Mapping Attributes (2005) definition further enhances the invention. With this addition, multiple mapping types may be defined. The Invention which had previously relied upon mapping events to values, now adds another dimension to the game: defining randomly generated game play cards. This new dimension now provides for the definition of games in which the player must match the numbers or symbols on a game play card, with the numbers or symbols of a draw. This new Attribute is defined through the Multi-Venue Administration Application (2009-1) as previously described for other attributes and contained in a Dual Mapped Game Database (2007). The Multi-Venue Administration Application (2009-1) accesses two different mapping applications for different purposes. Mapping Application A (2011) receives the Sequential Event Listings (2013) and uses the Random Number Generator A (2015) to create the Mapped Event Listing A (2017). This is consistent with other embodiments previously described. Now the Multi-Venue Administration Application (2009-1) uses Mapping Application B (1019) in conjunction with Random Number Generator B (2021) to generate the Mapped Listing B (2023) which creates the game play cards (not shown). Both the Mapped Event Listing A (2017) and the Mapped Listing B (2023) are used by the Multi-Venue Administration Application (2009-1) to further define game play and create the game application (not shown).

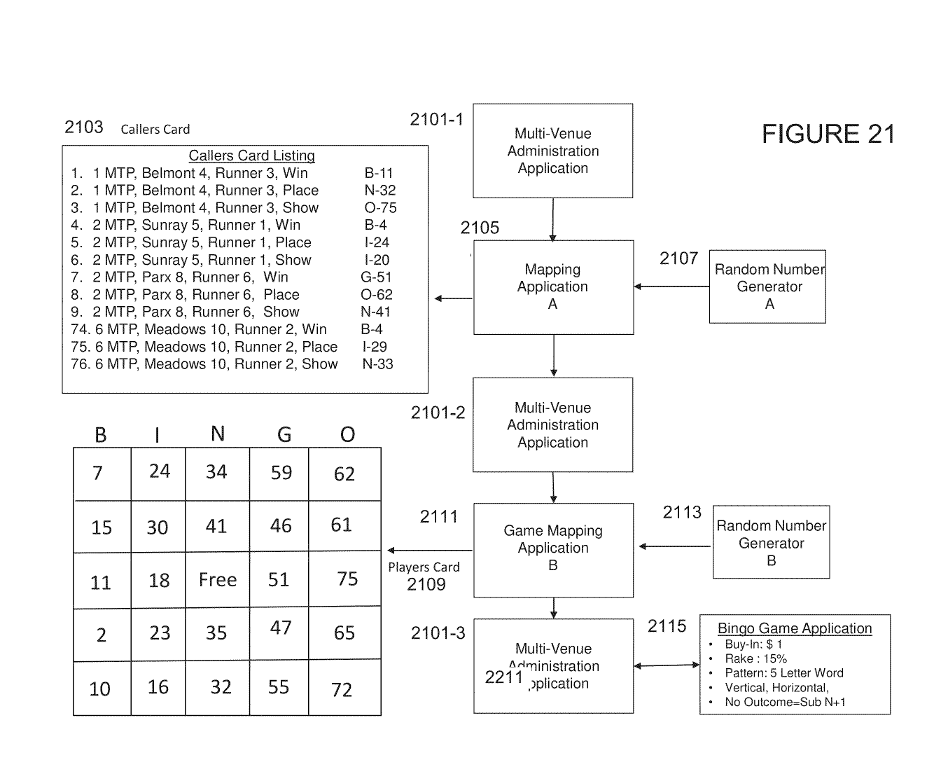

FIG. 21 is a block diagram depicting the creation of the Bingo Game Application, Callers Card and Players Card, and displaying other game play attributes. Bingo is the preferred embodiment of the enhancement to the Invention described in FIG. 20. In FIG. 21, the creation of the game using the dual random number generators is illustrated. With the Game attributes having been defined (not shown), the Multi-Venue Administration Application (2101-1) uses the Random Number Generator A (2107) and the Mapping Application A (2105) to create the Callers Card (2103) which is the map of Bingo Values to Event Values which will be displayed as the ball drop. By using the Mapping Application A (2105) and the Sequential Listing of Events (not shown) the balls of a bingo game are mapped to Events. Next the Multi-Venue Administration Application (2101-2) will create the game play or Players Card (1109). This is done by using a Random Number Generator B (2113) with a programmed Game Mapping Application B (2111) which specifies the layout of the card. Players Cards (2109) for multiple players are then defined and offered for sale. With both the Callers Card (2103) and the Players Cards (2109) defined, the Multi-Venue Administration Application (2101-3) creates the Bingo Game Application (2115) and integrates the Pool and Payout Database (not shown), making the Bingo Game Application (2115) ready for integration with an ADW operator (not shown).

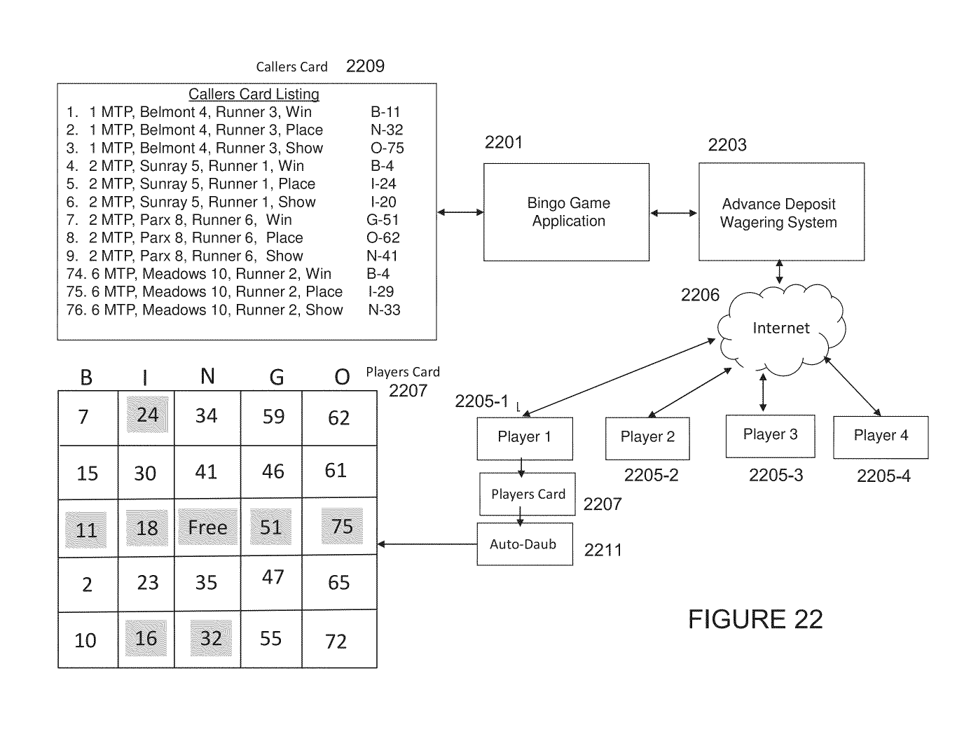

FIG. 22 is a block diagram depicting the Bingo game Play Application and game play through and Advance Deposit Wagering System. Bingo Game Play is illustrated in FIG. 22. The Bingo Game Application (2201) is integrated with the Advance Deposit Wagering System (2203) which has been previously described. As before, the Players (2205-1 through 2205-4) are connected to the ADW operator via the Internet or other communication device (1206). The Players (2205-1 through 2205-4) may purchase one or more unique Players Cards (2207) for each game prior to the commencement of the first event. When the game begins, the ball drop is based on the Caller's Card (2209). Each Players Card (2207) is electronically marked, or daubed, by the system for matching values. This process is known as auto-daubing (2211) and removes human error or oversight during game play. The Bingo Game Application (2201) continues play according to the Game Attributes previously defined until a winner is determined. If the game produces no winner, the pool is rolled into the next game and a progressive jackpot is established. Multiple patterns for secondary prizes may also be defined. In this example, Player 1 (2205-1) has a bingo. The Bingo Game Application (1201) will automatically record the bingo. In the case of one or more bingo winners, the system will declare a tie for the pool, and allocate the pool equally among the winners.

Primary Game Play as relates to this application is described in U.S. Pat. No. 8,616,947, titled “METHOD AND SYSTEM FOR CONDUCTING CONCURRENT, MULTI-VENUE, MULTI-RACE, MULTI-OUTCOME,” which is incorporated herein by reference, wherein 25 sequential horse racing events are identified, a Pick-N pool is established and game play is based on matching predictive outcomes displayed on a game play card to win the pool. Such pools are defined by the Racing Commissioner International and are easily adapted to this style of play.

In order to add secondary game play attributes, the pooling invention first documented in the above patent is expanded to any finite number of defined events whose positive predictive outcome becomes the basis of the pool. Further, each of these positive predictive outcomes is mapped through the use of a random number generator to a value which may or may not have value in and of itself, however when taken in conjunction with other mapped values, creates a combined weighted value. This combined value determines the winning outcome(s) which then share in the proceeds of the pool. The universe of predictive outcomes that define the finite number of predictive outcomes is determined by the type of game to be played. The pool size for the game to be played may be anything based upon well-known pari-mutuel wagers, or new unique wagers as defined by game developers understanding the power of the invention. Regardless of the game play developed, money is always placed into a pari-mutuel pool as per the generally recognized standards governing pari-mutuel horse and dog racing. For example, in the exemplary card game, the finite number of positive predictive outcomes is 52 (fifty-two); relating to the number of cards in a deck. The pool which determines the game play is a Pick-7 (there are 7 (seven) cards in the player's hand, which in total represent the player's entry in the Pick-7 Pool). Individual mapped outcomes to the cards may or may not have value in and of themselves, however taken in combination with other mapped values, create a weighted value that defines a winning hand.

To employ the invention as a single-mapped secondary game, a Multi-Venue Application Server generating sequential listings is controlled by a Multi-Venue Administration Application. The Administration Application accesses the Single-Mapped Game Database where Game Rules, Game Play Attributes and Mapping Attributes are stored. Once a game is defined by the Administration Application, a Mapping Application creates a mapped event listing by mapping the sequential events to the cards which were “shuffled” by the Random Number Generator. The resulting output is a Defined Secondary Game.

In one embodiment, the common game of poker may be demonstrated. The Game Rule Attributes are described wherein the actual process of playing the game is delineated; blind amounts, how cards re dealt, betting protocols, determination of winning hand, etc. The Game Play Attributes are also defined; buy-in amounts, definition of rake and rake amounts, the number of players, etc. This is where variations of the same game can be defined to cater to players of a specific ability level. The Mapping Attributes define how a game will be mapped. A key element of this design is the definition of protocol in the circumstance where an event does not produce the predictive outcome; therefore the outcome cannot be mapped to a specific card. Without an outcome there is no map. A new predictive outcome may be mapped to ensure the integrity of the shuffle while maintaining the premise of horse racing pools based on the quantified success of predictive outcomes. Options for the replacement of the event are defined; replace with the next event, map to the last event (essentially move the card to the end of the shuffle) or substitute current map. The end result of this logic will ensure that prior to the conclusion of the game, all cards will have been mapped and all pooling requirements will be satisfied. In this embodiment, only one deck of cards is mapped to support multiple tables of participants, each in their own game. Each table of participants will utilize its own shuffler to determine the card value as dealt to each player.

The Game Play Application for the Secondary Game of poker is linked to an Advance Deposit Wagering system, or ADW. The ADW is a commonly utilized service for the placement of wagers on horse racing events. Player accounts are stored with the ADW facilitating the movement of wagers during game play. The ADW manages the Rake Account as defined by the game. The ADW will also ensure the disbursement of winnings as determined at the end of game play and move the money from the Rake Account specific to that game into an Operator Account from which the operator derives revenue.

In another embodiment, dual random number generators are used. This embodiment fulfills the requirement of many draw-based games where players buy a game card and match their selection, or the select ion on the card, to the draw. Games of this kind include lottery or bingo games although any manner of game where the player matches numbers, symbols or images to a system generated draw may be defined under this Continuation. As in the first example, the first random number generator is used to create mappings of the sequential event listing. This mapping is used as the “draw” of the game. A second random number generator is used to produce game play cards.

Utilizing multi-venue, multi-outcome based events provides the user with outcome opportunities in rapid succession increasing the speed of game play. Further the random mapping of an event based on the favorite provides the game play a probability of success that can be enjoyed without prior knowledge in the sport of horseracing. The multi-random architecture employed; random matching of events to outcomes; unknown probabilities of outcome or racing events; and the random generation of game play cards ensures that all players have an equal opportunity of winning and results in fair game play for all contestants. The overriding principal of utilizing sequential, pari-mutuel events to define a fixed opportunity for entry and; whose outcome is based on the comparison of a pre-determined selection and an actual result, provides the foundation for embodiments utilizing fixed-odds based payouts where the pari-mutuel pool payout is replaced by a defined payout which may take the form of a secondary prize. It also has application in the realm of contests and fantasy games whereby points replacing real money are used as a scoring mechanism for the opportunity to win a prize, and lottery applications whereby an element of chance is inherent in the placement of the entry.

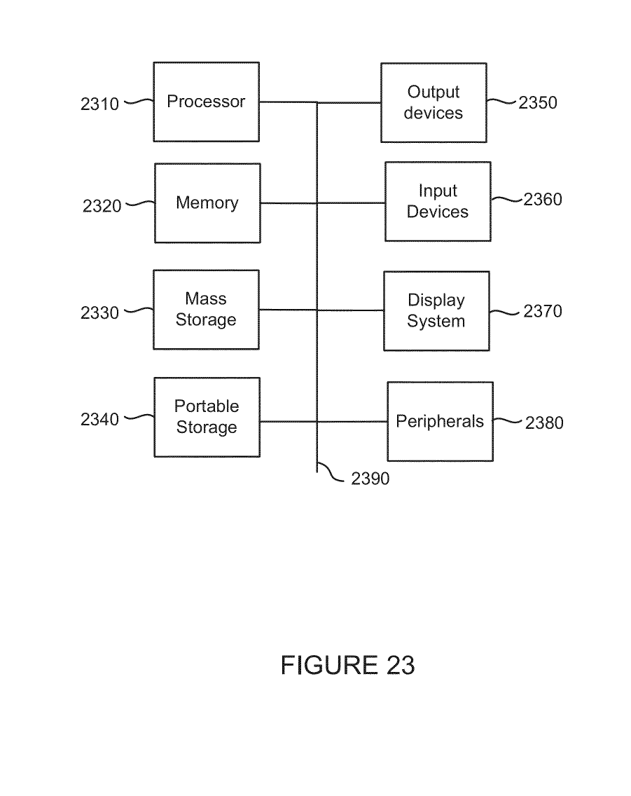

FIG. 23 illustrates an exemplary computing system 2300 that may be used to implement a computing device, server, mobile device, or other computing device for use with the present technology. The computing system 2300 of FIG. 23 includes one or more processors 2310 and memory 2320. Main memory 2310 stores, in part, instructions and data for execution by processor 2310. Main memory 2320 can store the executable code when in operation. The system 2300 of FIG. 23 further includes a mass storage device 2330, portable storage medium drive(s) 2340, output devices 2350, user input devices 2360, a graphics display 2370, and peripheral devices 2380.

The components shown in FIG. 23 are depicted as being connected via a single bus 2390. However, the components may be connected through one or more data transport means. For example, processor unit 2310 and main memory 2320 may be connected via a local microprocessor bus, and the mass storage device 2330, peripheral device(s) 2380, portable storage device 2340, and display system 2370 may be connected via one or more input/output (I/O) buses.

Mass storage device 2330, which may be implemented with a magnetic disk drive or an optical disk drive, is a non-volatile storage device for storing data and instructions for use by processor unit 2310. Mass storage device 2330 can store the system software for implementing embodiments of the present invention for purposes of loading that software into main memory 2320.

Portable storage device 2340 operates in conjunction with a portable non-volatile storage medium, such as a floppy disk, compact disk or Digital video disc, to input and output data and code to and from the computer system 2300 of FIG. 23. The system software for implementing embodiments of the present invention may be stored on such a portable medium and input to the computer system 2300 via the portable storage device 2340.

Input devices 2360 provide a portion of a user interface. Input devices 2360 may include an alpha-numeric keypad, such as a keyboard, for inputting alpha-numeric and other information, or a pointing device, such as a mouse, a trackball, stylus, or cursor direction keys. Additionally, the system 2300 as shown in FIG. 23 includes output devices 2350. Examples of suitable output devices include speakers, printers, network interfaces, and monitors.

Display system 2370 may include a liquid crystal display (LCD), LED display, touch display or other suitable display device. Display system 2370 receives textual and graphical information, and processes the information for output to the display device.

Peripherals 2380 may include any type of computer support device to add additional functionality to the computer system. For example, peripheral device(s) 2380 may include a modem or a router.

The components contained in the computer system 2300 of FIG. 23 are those typically found in computer systems that may be suitable for use with embodiments of the present invention and are intended to represent a broad category of such computer components that are well known in the art. Thus, the computer system 2300 of FIG. 23 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for conducting a wager, the method comprising:
generating a plurality of events by an application, the plurality events including future events from multiple races at multiple venues;
randomly associating each of the plurality of events with an alphanumeric or symbolic character;
generating a playing grid for a user, the playing grid including a randomized selection of the alphanumeric or symbolic characters, the randomly selected alphanumeric or symbolic characters provided within the grid; and
defining a wager by specifying a predictive pattern-based outcome for a game associated with one or more of the playing grids.

2. The method of claim 1, further comprising randomly assigning each of the plurality of events with a position in a matrix, wherein each of the alphanumeric or symbolic character are randomly assigned to a matrix position.

3. The method of claim 1, further comprising providing simultaneous play from a server, the simultaneous play provided through multiple distinct presentations of one or more pools through random mapping of the plurality of events to alternative alpha/numeric or symbolic characters.

4. The method of claim 1, further comprising:
determining that a previously identified racing event did not produce an outcome; and
associating an additional event to the alpha/numeric or symbol character associated with the event that had not produced an acceptable outcome.

5. The method of claim 5, further comprising repeating the step of associating an additional event to the alpha/numeric or symbol character until game play is completed.

6. The method of claim 1, further comprising comparing the mapped predictive outcome of the racing events with pattern matches of the game play card determining winning entries based upon one or more game rules.

7. The method of claim 1, wherein secondary prizes may be identified and paid from the pool.

8. The method of claim 1, further comprising:
assigning a value to each alphanumeric or symbolic character; and
storing the value in a database.

9. The method of claim 8, further comprising determining a hierarchy of combined values based on at least one game rule.

10. A non-transitory computer readable storage medium having embodied thereon a program, the program being executable by a processor to perform a method for conducting a wager, the method comprising:
generating a plurality of events, the plurality events including future events from multiple races at multiple venues;
randomly associating each of the plurality of events with an alphanumeric or symbolic character;
generating a playing grid for a user, the playing grid including a randomized selection of the alphanumeric or symbolic characters, the randomly selected alphanumeric or symbolic characters provided within the grid; and
defining a wager by specifying a predictive pattern-based outcome for a game associated with one or more of the playing grids.

11. The non-transitory computer readable storage medium of claim 10, the method further comprising randomly assigning each of the plurality of events with a position in a matrix, wherein each of the alphanumeric or symbolic character are randomly assigned to a matrix position.

12. The non-transitory computer readable storage medium of claim 10, the method further comprising providing simultaneous play from a server, the simultaneous play provided through multiple distinct presentations of one or more pools through random mapping of the plurality of events to alternative alpha/numeric or symbolic characters.

13. The non-transitory computer readable storage medium of claim 10, the method further comprising:
determining that a previously identified racing event did not produce an outcome; and
associating an additional event to the alpha/numeric or symbol character associated with the event that had not produced an acceptable outcome.

14. The non-transitory computer readable storage medium of claim 14, the method further comprising repeating the step of associating an additional event to the alpha/numeric or symbol character until game play is completed.

15. The non-transitory computer readable storage medium of claim 10, the method further comprising comparing the mapped predictive outcome of the racing events with pattern matches of the game play card determining winning entries based upon one or more game rules.

16. The non-transitory computer readable storage medium of claim 10, wherein secondary prizes may be identified and paid from the pool.

17. The non-transitory computer readable storage medium of claim 10, the method further comprising:
assigning a value to each alphanumeric or symbolic character; and
storing the value in a database.

18. The non-transitory computer readable storage medium of claim 17, the method further comprising determining a hierarchy of combined values based on at least one game rule.
